(19) United States
(12) Patent Application Publication
(10) Pub. No.: US 2003/0004853 A1
(43) Pub. Date: Jan. 2, 2003

(54) Graphical front end system for real time security trading

(76) Inventors: Pranil Ram, Toronto (CA); Crispin M. Almodovar, Makati City (PH)

Correspondence Address: MARKS & CLERK, 350 BURNHAMTHORPE ROAD WEST, SUITE 402, MISSISSAUGA, ON, L5B 3J1, CA

(21) Appl. No.: 09/892,891

(22) Filed: Jun. 28, 2001

(51) Int. Cl. G06F 17/60

(52) U.S. Cl. 705/37

(57) ABSTRACT

An interactive graphical front end system for use in trading securities provides a GUI display where buy and sell orders at specific prices for any selected security at any instant in time are displayed, and where the data is displayed for more than one market trading participant. The graphical front end is used by any trader who buys and sells securities in real time; the graphical interface permits the use of active cells on the display to instruct and complete a buy or sell order of any security at any price, at any instant in time when the data for that security is being displayed. Appropriate protocols are employed, along with the necessary translators, for transparent trading action from the viewpoint of the trader; who is able to track his holdings and cash position at any instant in time.

### FIELD OF THE INVENTION

The present invention relates to software which may be employed by individual traders who trade in real time with respect to securities they hold or securities they wish to hold. The present invention provides an interactive graphical front end system whereby active cells on a computer display grid are linked to computer code, so that a seamless and transparent transaction instruction may be given. More especially, the present invention provides a graphical manner by which various buy or sell orders, and changes, cancellation, or routings of trading orders, may be graphically displayed and manipulated with varying amounts of data being displayed. The present invention is relevant to any securities or commodity market where data concerning the interests of buyers and sellers in any defined commodity type, can be displayed. Moreover, since the display functions in real time, a trader will receive a dynamic representation of existing market conditions at that instant in time with respect to any selected security.

### BACKGROUND OF THE INVENTION

There are a number of trading systems, and a number of individuals, who engage in real time day-to-day or minute-to-minute security trading. Very often, such individuals are referred to as day traders.

Moreover, many stock brokers have an interest or duty to observe the dynamics of the market, including price fluctuations and volume of trading in any security.

There are a number of sources of data which contain up to the minute reports as to securities trading; such as RealTick™, CyberX™, and CyberTrader™. If any day trader, stock broker, or even casual trader, wishes to invoke a buy order or sell order, it may be necessary to follow a complicated procedure. That procedure may include having to place an order on paper or by telephone or facsimile, or internet, and then waiting to see if the order can be fulfilled.

However, even some proprietary software which is available for use by such individuals as day traders and stock brokers may require considerable key stroke input, and may not provide a dynamic display which indicates not only current market conditions but, by being observed over a period of time, such dynamic display would indicate what the market is doing with respect to a particular security. For example, CyberTrader™ requires that a user shall first enter the ticker symbol for a selected security, then enter the price, then the number of shares, and finally click on a confirmation button. As will be explained hereafter, the present invention permits the user to effectively drag and drop an icon representing a selected quantity of a selected security, with a selected trading order, over a grid to a selected cell having a selected price, and dropping the icon so as to effect the desired trading order.

Graphical displays in keeping with the present invention will indicate whether the market is moving up or down, whether there is a high volume or low volume of trades occurring at the present time, and even the number of buy or sell orders that may be in place, and at what price, as they may be being handled by any market trading participant.

The trader to whom the present invention is particularly directed is usually, but not necessarily, a sophisticated trader, who is interested in the dynamics of the market, and who is interested in obtaining data for any selected security at any instant in time, as well as to watch the changes in market conditions as they may effect that security over a period of time.

The present invention provides means, including particularly a graphical user interface, to permit the trader to achieve the goals set forth above.

While the present invention is particularly directed to an interactive graphical front end system for use in trading securities, it necessarily includes all of the appropriate physical architecture and logical architecture—at least, in functional terms—that are necessary in order to facilitate operation of the present invention.

Of course, it will be understood that the present invention contemplates the existence throughout the network of traders and market trading participants, of secure and high speed communications channels, and of sufficiently powerful and high speed computer hardware to function appropriately and to assure seamless and transparent functionality and operation of the market overview and security trading functionalities of the present invention. The present invention also contemplates that propriety software which embodies features, functions, and particulars of the teachings herein, will be resident in any computer hardware at the site of any trader practising or operating this invention.

### SUMMARY OF THE INVENTION

To that end, the present invention provides an interactive graphical front end system for use in trading securities through established security trading markets, in real time, where the system comprises a graphical user interface for use by any interested trading individual—referred to hereafter as a trader—, a system server, communication channels, and backend systems used by any market trading participants.

Communication channels are established between any trader's graphical user interface and a system server, and between the system server and the market trading participant's backend systems.

The graphical user interface for each trader is adapted to receive securities data through the system server from a plurality of market trading participants, in real time. Any trader may select the particular security for which data are electively required, at any instant in time.

The graphical user interface comprises transactional software to forward transaction instructions towards a communication channel, and it also comprises data handling software.

The securities data comprises data as to buy, sell, and other trading orders existing at that instant in time for any selected security.

The graphical user interface for any trader presents the trading order data for any selected security, at any instant in time, by presenting a display on a computer screen, which display comprises at least one grid comprising a plurality of cells. Any selected cell displays specific trading order data, and the trading order data displayed in any cell differs from the information displayed in any other cell.

The plurality of cells is presented in a plurality of rows and at least one column. Each row indicates a price or price range for which trading orders exist, and each column is indicative of a specific criterion chosen from a plurality of selected criteria within which the trading data may be sorted as to price or price range.

A trader may execute, or alter any trading order for a selected security being displayed at that instant in time by clicking on a selected cell, or moving a cursor or pointing device over that cell in such a manner that the transactional software will transmit an appropriate transaction instruction to the respective communication channel, and thence to any market trading participant.

Typically, the interactive graphical front end trading system of the present invention is such that the trading data is presented in a plurality of rows and a plurality of columns.

Each selected cell, and each trading order transaction, is linked to a respective one of a set of GUI objects which are included in software at each trader's graphical user interface front end computer.

The system further comprises protocol translators for translating the data and instructions sent over any communications channel, into a language which is understood by a computer at any trader's location or at any market trading participant's location.

The system server has logical components therein to execute any trading order instruction issued thereto from a trader or from a market trading participant.

The graphical user interface for any trader has a local database relevant to that trader.

The system server has a central database relevant to the system.

In the system of the present invention, the selected security for which the data is displayed at any instant in time may be changed to another selected security by the software at each trader's location, at intervals selected by that trader. Moreover, while the data for any selected security for which the securities data is being displayed at any instant in time, by any trader, is being constantly updated by being refreshed having regard to new trading data being received by the graphical user interface for that selected security.

Any backend system which is used by any market trading participant will perform at least the following tasks: account management for each trading account being handled by that market trading participant; processing trading orders for each transaction which that market trading participant undertakes to perform; order execution, whereby each transaction which that market trading participant undertakes to perform, is executed; datafeed handling, whereby the data concerning any trading order being handled by that market trading participant for any selected security is fed to the system server for dissemination on request to any trader; and system management for purposes of maintaining security and operation of the respective backend system of that market trading participant.

As to the market trading participants, they may be stock brokers, approved electronic communication network trading systems (ECN's), stock exchanges, commodity exchanges, futures exchanges, bourses, and auction servers. All of those market trading participants, in one way or another, are involved in established security trading markets; and all of those market trading participants engage in buying and selling of securities.

Such securities are usually shares in publically traded companies; but they may be commodities such as soy beans and pork bellies, they may be futures with respect to commodities or shares, they may be derivatives based on an underlying security, or puts, calls, or other share based options or contracts; or they may be objects that are being sold at auction over internet-based auction systems.

The data communications over the communications channels are in keeping with protocols which are established to standardize data interchange format between the respective parties communicating over any respective communications channel, using secure data encryption modes.

Any backend system of any market trading participant may further comprise a middleware system whose purposes include the following tasks: connection pooling, whereby securities data to and from that market trading participant is pooled and controlled so as to maintain the integrity thereof; application server to assure access by the backend system to any required software or software modules in order to perform any required function intended to be carried out by that market trading participant; and security management, whereby the security of the backend system against unwanted hacker intrusion is assured.

Any data concerning any security holding which is held by any trader is represented the display for that respective trader by at least one icon which is linked to a respective GUI object in the software at that trader's graphical user interface. Also, any selected quantity of cash in selected units thereof is represented on the display for that respective trader by at least one icon which is linked to a respective GUI object in the software at that trader's graphical user interface.

Further, additional icons may be used to represent specific quantities of units of any selected security, and additional icons may be used to represent selected amounts of cash. In each instance, each additional icon is also linked to a respective GUI object in the software at the trader's graphical user interface.

The software at any trader's graphical front end is application software, which is contained in a computer at the respective trader's location.

Also, the respective data which is displayed in any selected cell at any instant in time, may comprise a plurality of specific components which relate to selected parameters surrounding that data.

Having regard to the dynamic graphical display, in some instances at the election of the trader, a plurality of columns of cells may be assigned to any one of a plurality of market trading participants. Thus, each cell may represent only one specific trading order being posted by the respective market trading participant for the selected security being displayed at any instant in time.

Also, only a selected quantity of the best buy orders and a selected quantity of the best sell orders which are being posted by the respective market trading participant for the selected security may be displayed.

Any cell on the graphical display that has more than one trading order for the respective market trading participant at the respective price indicated by that cell, may also be marked to show the number of trading orders that are represented by that respective selected cell.

If so, there is a link to a respective GUI object in the software at any trader's graphical user interface for each number being displayed in a respective cell having more than one trading order.

Further data may also be embedded in each respective trading order cell, in the data for that respective cell, which further data may be revealed by clicking on the cell.

In that case, the further data will at least include an indication of the number of units of the selected security for which the respective trading order has been placed.

If so, there is a link to a respective GUI object in the software at any trader's graphical user interface for the respective data being displayed.

The display at any trader's location may further include Level I data for the selected security at that instant in time.

Such Level I data will include data which is chosen from the following group: the exchange where the selected security is being traded, the current bid price, the current ask price, the last sold price, the size of the last transaction in terms of the number of units of the selected security traded, the change in the price of the last trade with respect to the immediately preceding trade, the volume in terms of the number of units of the selected security that had been traded during the current trading session, and combinations thereof.

A standard protocol is interfaces is provided so as to define the format of instructions and data that are exchanged between any trader—that is, for communication from the graphical interface client front end 32 of that trader—and any backend system 44. That standard protocol may be based on the XML language.

Each of the input parameters and each of the return value items noted above, is also linked to a respective GUI object in the software at any trader's graphical user interface.

The plurality of cells which are displayed may be arranged in a plurality of grids each having rows and columns of data, and which are graphically presented on a plurality of graphical tabbed pages. Each page may be is selected by clicking on its respective tab.

In such multiple tabbed page display, a transaction may be effected by dragging and dropping an icon which is representative of a specific trading instruction, from one tabbed page to another tabbed page.

In one important aspect of the present invention, a transaction which changes a previous instructed transaction is handled by the transaction software, so as to appear to the trader as a single transaction.

A particular feature of the present invention is that any trading order transaction may be effected by dropping an icon which is representative of the specific transaction onto a selected cell, whereby the transaction software will issue a respective transaction instruction through a respective communication channel to a respective market trading participant.

However, any such trading order transaction which has been placed but not yet effected, may be cancelled by dragging the respective icon away from its respective selected cell.

In the graphical display grids of the present invention, the price value for each row may be selectively adjustable as to the price or price range being represented by that row. Also, the relative position of any row with respect to any other row may be adjusted, along a price axis.

Such adjustment may electively be under the control of the trader, or the adjustment of the price value, and the adjustment of the relative position for each row, may be under the control of the data handling software.

In any grid display in keeping with the present invention, the range of price values for all of the rows along the price axis thereof which are displayed, and the price value for a selected row, may be determined for each selected security at any instant in time as a factor of one of the criteria chosen from the group consisting of: the last closing price for that security, the opening price for that security, the highest price paid for that security, the highest price bid for that security, the lowest price paid for that security, the lowest price bid for that security, and the last price paid for that security.

Also, for any grid display in keeping with the present invention, the criterion—that is, the heading—for the at least one column of cells for data which may be displayed in that column, may be chosen from the group consisting of: the identity of a market trading participant, aggregate trading order data from a plurality of market trading participants, aggregate buy order data from a plurality of trading participants, aggregate sell order data from a plurality of trading participants.

One alternative display format of the present invention allows for a displayed grid to further include a display page, for an integrated chat session.

In another aspect of the present invention, the graphical user interface for any trader may have memory means associated therewith. Thus, all securities data for any selected security, at a series of selected time intervals, may be stored in the memory, and a replay function for the data, to recall that data for a selected time period, may be selectively invoked by said trader.

The interactive graphical front end trading system of the present invention may further comprise software whose purpose is to review and weigh a trader's cash position and portfolio, so as to make a recommendation for a trading order concerning a selected security, at any instant in time, where the recommendation is a factor of at least the bid and ask prices for that security at that instant in time.

Of course, the graphical display at any trader's location may further display Nasdaq Level II data for a selected security at any instant in time. That Nasdaq Level II data includes data which is chosen from the group consisting of: the identity of each market trading participant whose data is being displayed, the last price paid, the change between the last price paid and the previous price paid, the percentage change between the last price paid and the previous price paid, the current bid price, the current ask price, the highest price paid within a predetermined period of time, the number of shares traded in the last trade, the number of shares traded during a current trading session, the number of trades during the current trading session, the number of current bidders, the number of current sellers, the lowest price paid within a predetermined period of time.

The interactive graphical front end trading system of the present invention may permit any of the rows and the at least one column, to have a graphical control button associated therewith. Accordingly, the status of that row or column may be changed under the control of the data handling software.

In any aspect of interactive graphical front end trading system of the present invention, a specific color may be assigned for each different type of trading order data which is displayed in any selected cell.

### PRIOR ART

U.S. Pat. No. 6,058,379, issued May 2, 2000 in the name fo Odom et al teaches a networked exchange method in which a commodity may be traded from a seller to a purchaser using an exchange processor. A mode of operations for an exchange is specified, a commodity is identified and listed, and the listing is accessed by a potential purchaser. The potential purchaser accesses the network-based exchange, a negotiation occurs by processing information generated by the potential purchaser; and at the conclusion of the negotiation the concluded negotiation is cleared. All of the transaction software is driven by the exchange where the transaction is concluded.

Belzberg U.S. Pat. No. 6,134,535, issued Oct. 17, 2000, teaches a computerized stock exchange trading system where a graphic user interface is employed to automatically format orders from a spreadsheet to an order entry system. Parameters such as a share symbol, price selection, order size, and transaction type, as well as other indicators for the trading order, may be chosen using the graphic user interface and a mouse. The interface may be programmed so that data concerning a group of shares may be read from a spreadsheet which is formulated into an order, or in response to a signal from the trader whereby an index or basket of shares may be traded substantially instantaneously.

U.S. Pat. No. 6,195,647, issued Feb. 27, 2001 to The Nasdaq Stock Market, Inc., in the name of Martyn et al. This patent teaches a data processing system for on-line transactions whereby securities may be traded, wherein any user may configure his or her display so as to employ certain functions and to show displays for any particular security. Additional information may be displayed, such as information about selected securities, trade activity may be monitored, a trade may be participated in, or reported. It is also possible for a user to display information for a selective set of securities on a continuously updated basis, where any of the securities can be easily selected from a displayed list. Certain information and functions associated with the selected security may also be displayed.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a schematic representation of a prior art system employed particularly by stock brokers for trading purposes by remotely located traders;

FIG. 2 is another schematic representation of a different, browser-based front end system currently employed by brokers for remotely located traders;

FIG. 3 is a schematic representation of an architecture in keeping with the present invention;

FIG. 4 is a view similar to FIG. 3, showing logical architecture for the front end functional unit;

FIG. 5 is a block diagram of the internal architecture of the front end of a system in keeping with the present invention;

FIG. 6 is a block diagram of the order/transaction processing subsystem and order routing subsystem, in keeping with the present invention;

FIG. 7 is a block diagram of the account management subsystem;

FIG. 8 is a block diagram of the order execution subsystem;

FIG. 9 is a block diagram of a prototypical back-end trading system;

FIG. 10 shows a typical grid representation of data displayed at a trader's graphical user interface computer display;

FIG. 11 is a view similar to FIG. 10, but with the price data being shown in larger intervals;

FIG. 12 is a typical computer monitor display at a traders location, showing various kinds of data;

FIG. 13 is a view similar to FIG. 12, but showing additional data being displayed in a different manner;

FIG. 14 shows a detailed view of a holdings tab chosen from FIGS. 12 or 13, in greater detail;

FIG. 15 shows much the same data as in FIG. 14, but in icon format;

FIG. 16 shows data chosen from the market order entry tab, chosen from FIG. 12;

FIG. 17 shows data typically found on a limit order tab chosen from FIG. 12;

FIG. 18 shows data typically found on a stop order tab chosen from FIG. 12;

FIG. 19 shows data typically found on a change order tab chosen from FIG. 12;

FIG. 20 shows a representation of an open order tab, chosen from FIGS. 12 or 13;

FIG. 21 shows much the same data as in FIG. 20, but in icon format;

FIG. 22 is a view similar to FIG. 21, but showing a representation of a “right click menu” associated with an icon;

FIG. 23 shows a representation of a fill orders tab, chosen from FIGS. 12 or 13;

FIG. 24 shows data chosen from an options order tab, chosen from FIG. 12;

FIG. 25 is a view similar to FIG. 10, but showing a situation with falling “prices on a fixed price axis”;

FIG. 26 shows similar data to that of FIG. 25, but with the falling price being centred on the price axis;

FIG. 27 is a representation of prices for an option series, with one column showing an aggregate price;

FIG. 28 shows a typical price data display having a limit buy order;

FIG. 29 is similar to FIG. 28 with the limit buy order having been moved to another market trading participant;

FIG. 30 shows data from FIG. 29, but only displaying bid and ask quotes for each active market and with a limit buy order being shown;

FIG. 31 is a similar view to that of FIG. 29, but showing a stop loss limit order;

FIG. 32 shows a display of a stop loss limit order after the stop price has been triggered and the limit sell order is in effect;

FIG. 33 shows similar data to that of FIG. 31, but with a column showing aggregate data being displayed;

FIG. 34 shows the same data as FIG. 33, but with the lot size for each selected cell being shown;

FIG. 35 shows data for the aggregate column only of FIG. 34, but with additional graphical representation of lot size and orders;

FIG. 36 shows the data from FIG. 35 being shown horizontally, together with a chat screen for a chat session which is occurring;

FIG. 37 provides information for a single column quote data together with associated company chart and profile information;

FIG. 38 shows the same data as in FIG. 28, but with a “right click menu” having been activated for a selected “buy” cell;

FIG. 39 represents the settings which may be established when a replay tab is chosen from FIG. 12;

FIG. 40 is a representation of the settings which may be established when the “Position Guide” block from FIG. 12 has been chosen;

FIG. 41 is an optional display where data for three securities is shown being displayed horizontally;

FIG. 42 is a typical display showing “NASDAQ Level II” data being displayed;

FIG. 43 shows a box in which special terms criteria may be set for any transaction;

FIG. 44 shows a representation of an option chain for options concerning a particular security;

FIG. 45 is an alternative showing a data similar to FIG. 44, with a “right click menu” of column display choices being shown for displayed put data;

FIG. 46 is an alternative showing a data similar to FIG. 44, with a “right click menu” of column display choices being shown for displayed call data;

FIG. 47 shows data similar to that of FIG. 35, together with NASDAQ Level II data;

FIG. 48 shows a display having multiple buy and sell orders with their relative position to the bid and ask prices, together with actuating buttons for each price representation;

FIG. 49 shows an alternative mode of display to the data shown in FIG. 48;

FIG. 50 shows a typical multiple security display with a quote display associated with a selected column, and a highlighted tab;

FIG. 51 shows a consolidated quote view for selected securities within a selected grouping;

FIG. 52 provides similar data to FIG. 50, with each column being related to a specific security; and

FIGS. 53a, 53b, and 53c show the manner in which price data may be mapped to any selected cell, where the price range represented by that cell may be changing.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

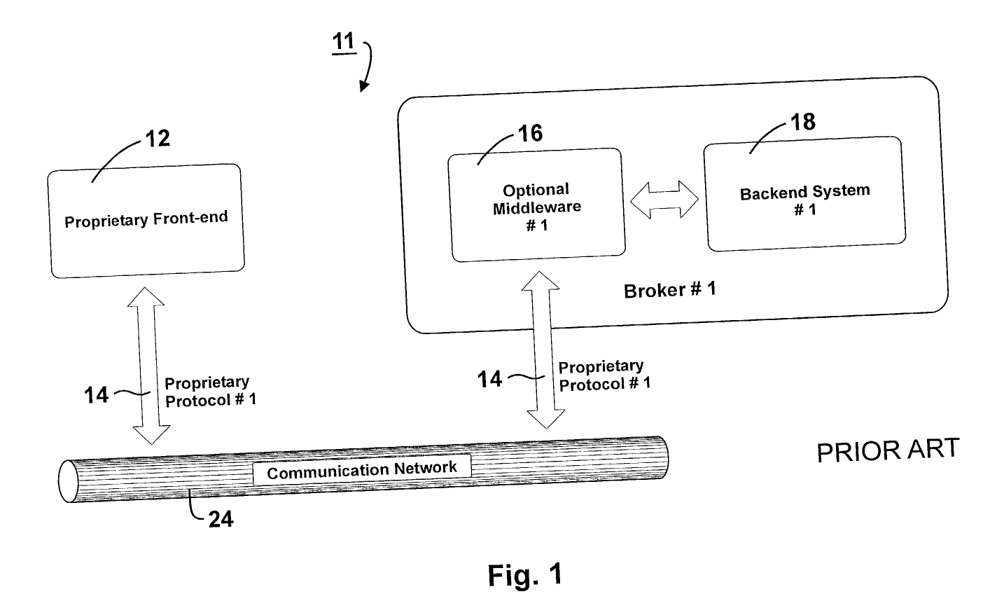

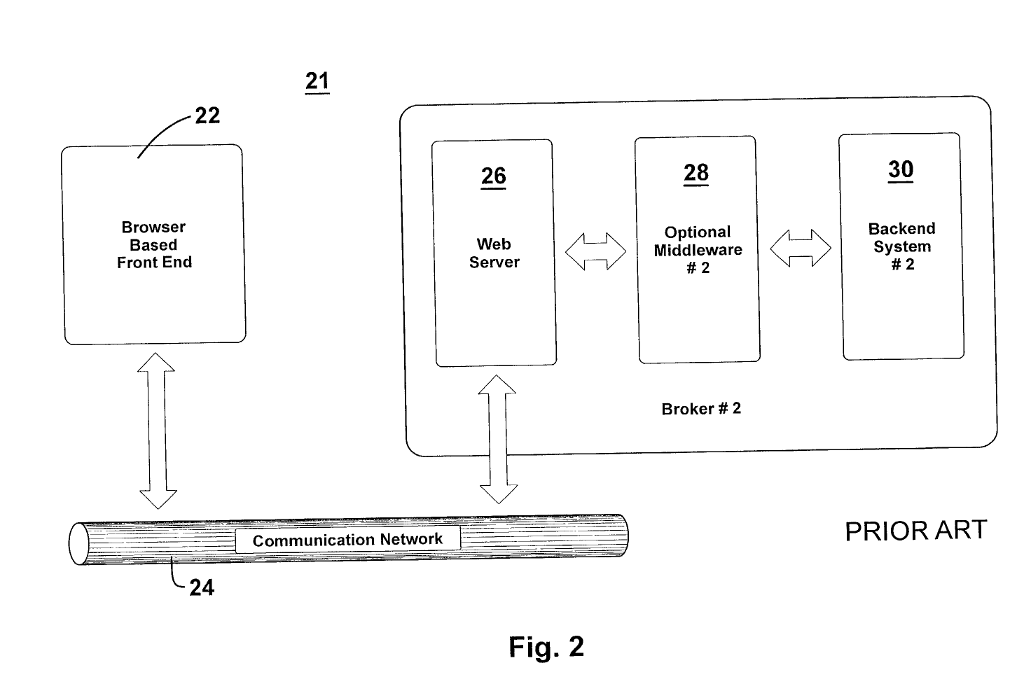

Turning first to FIGS. 1 and 2, two prior art systems are shown which employ different front ends. In the prior art system of FIG. 1, showing a system architecture which is in place and which is operated by Broker #1, the system 11 comprises a proprietary front end 12, a proprietary protocol 14, an optional middleware 16, and the backend system 18. The optional middleware 16 and the backend system 18 are located on the premises of Broker #1, who communicates through a proprietary protocol 14 to the proprietary front end 12.

In the prior art system of FIG. 2, the system 21 includes a browser-based front end. Such front ends are sometimes referred to as being Thin Client front ends.

Communication is carried out through the internet, as shown at 24. Within the premises of Broker#2, there is a web server 26, there may be optional middleware 28, and there is a backend system 30.

Either front end system 12 or 22 is what a trader will see on his computer, and it is the tool that the trader uses to get quotes, manage his account with the respective brokerage firm, buy and sell shares or securities in general, and to track his transactions. Simple front end systems tend to be implemented as web applications, as indicated in FIG. 2; however, a proprietary front end may also be employed. Any of these systems offer satisfactory performance, but tend to be limited in their interactive capabilities, due to security, portability, and speed issues. They are generally quite slow, because both the user interface and the data must be processed remotely at the web server or at the back end.

Of course, systems such as those shown in FIGS. 1 and 2 are easy to deploy, manage, and maintain, because of their centralization at the premises of the respective broker.

If a proprietary front end is used, that system involves the installation of application software at the local computer employed by the trader. Those systems tend to be somewhat faster and more graphical, and they may be more interactive than strictly browser-based applications, because the application is run locally. Of course, as with any locally installed software which is located at a desktop computer, or even on a small local area network operated by the trader, the software is prone to installation and maintenance problems, file corruption, version conflicts, and upgrade problems.

Either backend system 18 or 30 will exist in any embodiment of the present invention as well, because they are the backend systems that are operated by respective brokers, electronic communication network traders, or even stock exchanges, and the like. Any such backend system may likely reside in a high end UNIX machine. Any backend system has the responsibility for handling a number of tasks.

They include account management. This is the responsibility for managing and keeping all data up to date for each account—each customer or various accounts run by a customer—that is handled by that market trading participant. As noted, a market trading participant might be a broker, it might be an approved electronic communication network trading system, or it might be a stock exchange, commodity exchange, futures exchange, bourse, or auction system.

Another task charged to the backend systems which function in the prior art, and which function in association with the present invention, is that of processing buy orders and sell orders for each buy transaction and for each sell transaction which that market trading participant undertakes to perform.

Still further, the backend system is responsible for order execution, whereby each buy transaction and each sell transaction which the market trading participant undertakes to perform will, in fact, be executed.

The backend system is also responsible for datafeed handling, whereby the streaming data concerning any buy order or sell order being handled by that market trading participant for any selected security is provided to a system server for dissemination on request to any trader, as discussed hereafter.

Finally, any backend system described herein will also be responsible for system management, for purposes of maintaining security and operation of the respective backend system of that market trading participant.

A communication protocol is required in prior art systems, as well as in the present system. In the prior art systems, the communication protocol for proprietary front ends 12 is one which is used to securely transmit data from the proprietary front end 12 to the backend system 18, and in the reverse direction. Usually, such proprietary protocol is built on top of TCP/IP sockets, most likely using some form of data encryption.

For prior art systems of the sort shown in FIG. 2, where internet communication is employed, a typical communication protocol is HTTPS.

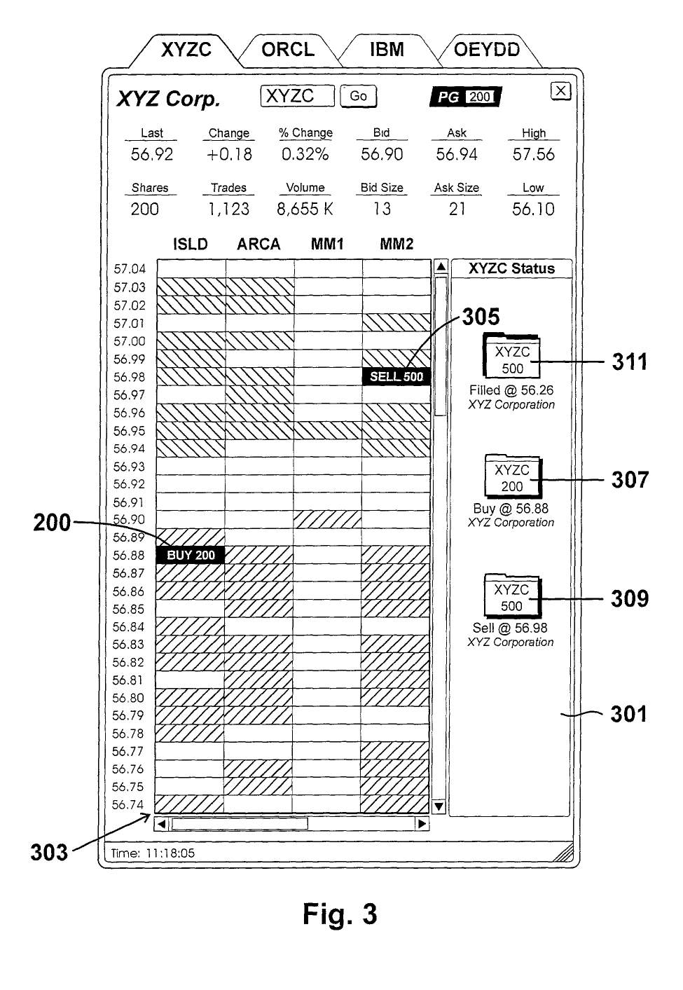

A middleware component is employed, as shown at 16 and 28 in FIGS. 1 and 2, or as will be shown in FIG. 3 which is discussed hereafter. The purposes for the middleware are discussed hereafter.

There is appended hereto a Trading Glossary, which is provided so as to assist the reader in understanding certain trading terms, and terms relating to market, in various manifestations. All of the terms mentioned in the appended Trading Glossary are not necessarily employed herein; but when such terms are employed, if their meaning is unclear from the context, the reference should be made to the appended Trading Glossary.

Also, throughout the discussion which follows, and as shown in many of the figures of drawings which are described, the names of real securities and of real stock exchanges and other market trading participants, Electronic Communication Network (ECN) trading systems, and the like, may be noted. The use of such names and identities is not intended to suggest any endorsement or connection with, or position in, any such security, stock exchange, or ECN, by the inventor or anyone associated with him.

Markets exist to bring buyers and sellers together to efficiently exchange goods and services. In a public marketplace, buyers and sellers make transactions, directly or via intermediaries. At a basic level, a market requires the sellers price and terms to sell a given quantity of product. The market participants also need to know the prices that buyers are willing to pay for an item. Often, the price per unit decreases if a larger quantity of product is under negotiation. When the buyers and sellers agree in price and quantity, a transaction or trade can occur.

In the securities market, the bid price represents the highest price any buyer is willing to pay for a quantity of security at a given time. The ask price is the lowest price that any seller or dealer is willing to sell a given security or commodity for. When the bid or ask price is in an acceptable range, trading activity in a given security will usually become more active.

Supply and demand prices vary throughout a trading session and the bid and the ask are typically at differing prices. The price difference between the current bid and the current ask of a given security is called the spread.

Information about the activity of a market is disseminated (usually in real-time) in electronic format through data feeds. A quote is a type of data feed containing information about the buy and sell prices for the securities traded on the market. Separate data feeds are available for trades, news, and other useful information.

Buy and sell quotes on marketable products are disseminated in varying detail. In financial markets like the stock markets, basic quote information on securities is readily available over the internet. A basic quote on a security details the last trade price, the bid and ask price, and the change from the previous close. Often, the size of the bid and the ask, the trading day's high price and low price, the volume of the last trade, and the overall session volume is also disclosed.

A more detailed quote is also available. The detailed quotes disseminated by the NASDAQ stock market is called “NASDAQ Level II”, or simply “Level II”. This quote is of interest to more active traders, because it allows them to track the activity of market makers that they believe to be price-trend setters. It also allows those with the capability, to buy and sell their positions quickly, when it becomes apparent from Level II information that the momentum of the markets has turned against them. With a Level II display, the identity of market makers and ECNs is disclosed and order information on either side of the bid and ask are visible. However, not all exchanges or markets provide order or quote information that allows a trader to view this detailed type of quote for all securities.

Still more detailed, are order and quote information displays provided by some Electronic Communications Networks (ECNs) such as Island ECN and Archipelago which can display buy and sell orders individually listed on the ECN's electronic limit order book. The order books list buy and sell orders, the number of shares in each order, and the prices offered. Orders are listed according to price and in time priority, so orders displayed close to the bid and ask on the list will be executed before orders further away in the list.

Not every quote feed from a stock exchange, stock market, electronic communications network, or quote dissemination service supplies a suitable data feed capable of providing information on the quantity of a security available at each price level during a given instant in time. Exchanges sometimes provide restricted access to similar information, however, some market participants prefer to keep quote and order details confidential.

Depending on the opportunity and technology available, more than one market or network may exist to facilitate trading in a given security or commodity. When more than one market exists for a given product, there is a tendency to link the market information together to compare quote information and trading activity. Technology and computer networks make possible the linkage of the data feed (quotes, trades, news, etc) and order-placement facilities of different markets. As a result of this linkage, bid and ask prices tend to mirror each other, as financial intermediaries such as arbitrageurs trade products between markets when price discrepancies arise.

There has been a trend in recent years to trade stocks and options in more than one market or exchange. Exchanges like the NYSE and stock markets like NASDAQ have made strategic alliances with overseas exchanges to promote trading activity and facilitate listing active securities in other countries. In the US, options on a given security are often quoted and traded in multiple options exchanges.

Quote data on securities is often presented in alphanumeric text format. When working with a basic quote, and more than one security is being monitored or traded, the quote data is displayed in multiple rows and columns of text similar to a spreadsheet. Each row represents a different security, while columns show attributes such as the securities' symbol, bid, ask, last trade, change from previous closing price, and the volume, low price, and high price of the current trading session.

The text based presentation is often difficult to interpret at a glance. Discerning patterns from the text based quote information of an individual stock or a group of stocks is also difficult. With experience, some traders develop buy and sell “indicators” which assist them in speculating on the direction of a given commodity or security.

The order placement process in many computer-based trading systems requires the user to interact with a form—which is a collection of graphical elements (e.g. text input area, label, button, etc) through which the user issues commands and/or keys data into the computer system. Once an order is placed, the status of the order and its relation to the market is not always spatially apparent. Similarly, desired changes to the resulting open order also take a forms-based approach, which often increases the time spent on the process as a result of the time necessary to refresh screens and download the revised data. The time taken to place a trade and to change an open order often requires that a trader shift attention to the mechanism of the user interface, rather than to maintain a focus on the market or the security in question, and hence obtain additional beneficial insight.

For securities, the minimum price variation (MPV) is the minimum amount by which the price of a security can change. The MPV is typically set by the primary marketplace for a given security or product. In investment terminology, the “bid” is the highest price a buyer is willing to pay for an investor's shares, while the “ask” is the lowest price at which a seller will sell shares. The difference between the two is called the spread. A smaller MPV will result in narrower spreads because there are more price points in buying and selling the securities.

Take, for example, a hypothetical stock with a bid price of 45¼ and an ask price of 45 5/16. The spread between the “bid” and the “ask” is 1/16 or 6.25 cents per share. In contrast, when stocks trade in penny increments, the number of price points per dollar is 100, meaning there are narrower changes in price increases and declines.

A smaller minimum price variation (MPV) will be possible as a result of the US exchanges and stock markets adopting a decimal format. Prior to decimalization, many U.S. equities were traded and quoted at an MPV of 1/16 or 6.25 cents, meaning there are sixteen price points or “ticks” per dollar. Option prices over $3.00 have an MPV of ⅛, allowing eight price points per dollar. With decimalization, option prices are expected to trade in 5 cent increments under $3.00, and in 10 cent increments above $3.00.

It is the intent of the present invention to present quote information for any market in a graphical manner, and hence assist investors and traders in gauging the direction and changes to a security or asset's quote, price, and volume activity over an interval of time. It is also the intent of the present invention to allow traders and investors to view and review quote and order information in aggregate form, or across multiple markets, in an organized and meaningful manner.

It is also an intent of the present invention to assist traders and investors in selecting the proper quantity of an item to buy and sell, and to graphically place the order to a selected market. It is a further intent of the present invention to execute change orders in a given parameter of an open order in a simple graphical manner that does not distract the trader or investor from the dynamics of the quote display, while monitoring the investment.

Referring to FIG. 3, some similarities and some differences will be noted with respect to FIGS. 1 and 2.

In the first instance, the system which is indicated generally at 10, and which is the general architecture for the present invention, includes a graphical user interface client front end 32—sometimes referred to herein as a GUI front end. The graphical user front end 32 communicates through a communication network 34 to a market trading participant 36. Protocol exchanges at 33 and 35 will accommodate internet communications using varying protocols, as is well known.

At the premises of the market trading participant 36, there may be a middleware component 42 installed, as well as that particular market trading participant's backend trading system 44.

Thus, the front end 32 may interface with diverse backend trading systems 44. Any market trading participant 36 may be such as a stock broker, an approved electronic communication network trading system (ECN), a stock exchange, a commodity exchange, a futures exchange, a bourse, or an auction server.

The ability for the front end 32 to communicate with diverse market trading participants 36 is possible because of the use of the middleware 42 which facilitates communication between the front end software running on the front end 32, at the PC of any trader or user, and the proprietary backend trading system 44 running on the heavily secured machines of the specific market trading participant 36.

As noted, the front end 32 does not communicate with the backend trading system 44 directly, but through the middleware 42, the communication network 34, as well as interfaces 33 and 35 and as necessary. The specifications of these interfaces will constitute a Market Trading Protocol (MTP), and that in turn is based on extensible Markup Language (XML). The middleware 42 will translate demands and data, which are encoded in MTP, which come from the front end 32 into the native format understood by the actual backend trading system 44. Commands and data coming from the backend trading system 44 are also converted to MTP format by the middleware 42, before it sends them back to the front end 32.

Thus, the front end 32 is shielded from the peculiarities of a backend trading system 44, which may be different for various market trading participants, and it allows the front end 32, and particularly the graphical display software and modes which are described hereafter, to be reused in other applications with minimal modification.

One important benefit of the middleware 42 is that it enables the market trading participant 36 to supplement the base functionality of its existing backend trading system 44 with new, value-added functionality. Thus, a set or series of backend operations may be grouped into a “virtual” operation. An example of this is an “order amendment” transaction, which will be described hereafter. In existing trading systems, an order amendment transaction requires that the user go through a two-step procedure: first, the original order is cancelled; then, a new order is issued. With the middleware 42 in place, a single virtual operation—the “order amendment” operation—can be invoked.

Of course, incorporating a series of operations into a single “virtual” operation is the responsibility of the respective market trading participant 36, and is transparent to the end user—the user or trader whose location includes a front end 32. The market trading participant 36 can offer the resulting “virtual” operation to its customers as a new type of transaction, and customers can make use of this new transaction just like any other type of transaction.

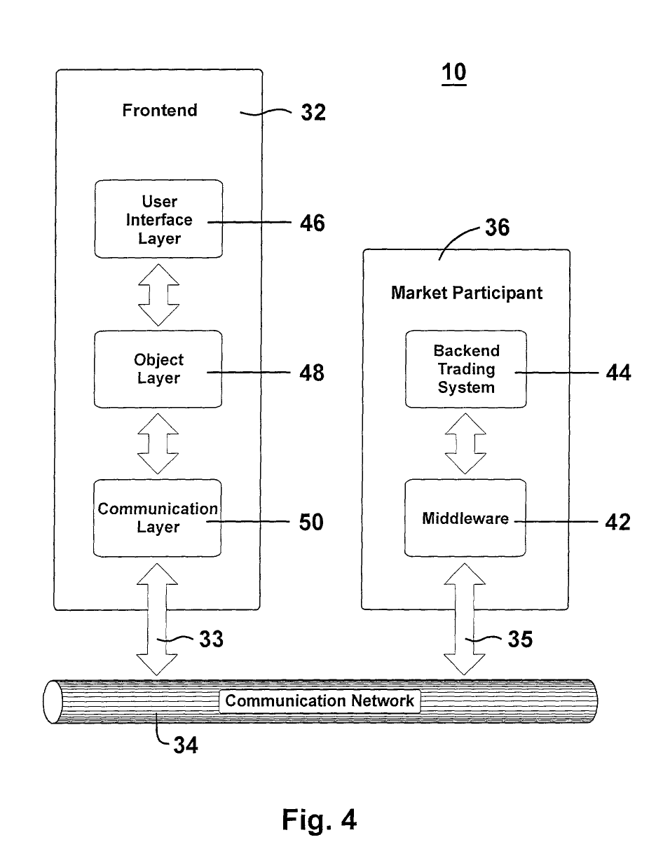

Turning to FIG. 4, the front end 32 has a three-layer logical architecture, consisting of the user interface layer 46, an object layer 48, and a communication layer 50. This design gives the front end 32 the advantage of a clean, organized structure, wherein related software functions are grouped in independent layers, each layer communicating with the others using clearly defined programmatic interfaces.

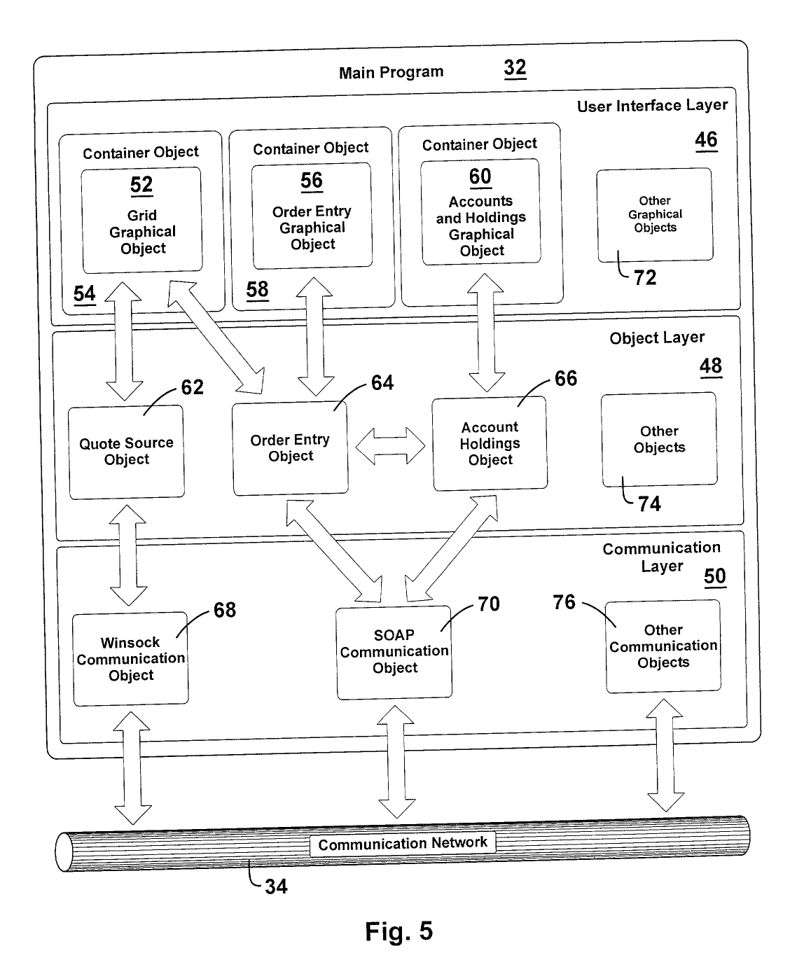

The user interface layer 46 contains components that handle the graphics operations of the grid and other graphical objects. These include the construction of the grid (using either an object-based approach, or using a frame-by-frame animation approach); dynamic operations such as moving and highlighting the cells of the grid; and interactive operations like responding to user actions, e.g. adjusting the price intervals on the vertical axis when the user clicks on the appropriate graphical element (e.g. a button). These matters are discussed hereafter, with reference to FIG. 5.

The object layer 48 groups together components that perform business logic, and components that implement utility functions. The components in this layer: (1) validate users' actions (performed on objects belonging to the user interface layer 46); (2) translate users' actions into commands—if applicable—to be sent to the back-end trading system via the communication layer 50; and (3) process return values, notification messages, or any other data sent by the backend trading system (through the communication layer 50). The object layer 48 serves as an abstraction layer that shields the user interface layer 46 from the implementation of the lower level communication layer 50.

The communication layer 50 consists of components that act as communication “gateways” between the front end and the backend trading system. This layer essentially translates programmatic requests (which are in the native format of the operating system and application platform of the front end) coming from the object layer into Simple Object Access Protocol (SOAP) messages. It is to be noted that although SOAP is the primary protocol for front end 32 to middleware 42 communication, other suitable protocols—such as Winsock—can also be employed. The specifications of the format of the SOAP messages form the Market Trading Protocol (MTP).

The communication layer 50 is designed to accommodate the “plug-and-play” addition and removal of communication components, each component implementing a specific type of communication protocol (e.g. Winsock, SOAP) for interfacing with the backend trading system 44.

It will now be seen that the GUI front end 32 is the essence of the present invention, and it provides a graphically intuitive, fast, user-friendly application that any trader will use in order to get stock or other security quotes, manage their account with their respective brokerage firm or other market trading participant, buy and sell securities and stocks, track the status of those transactions, and track their current position vis-a-vis any selected security, their cash position, and so on.

Typically, the GUI front end 32 operates on a Windows® platform, but not necessarily. Other platforms may also be employed, including LINUX®, and other proprietary platforms.

As will be discussed hereafter, the GUI front end is employed to display security data in a dynamic fashion, very intuitively, and allows the trader to buy or sell securities with simple mouse clicks by employing active cells which are displayed, and by moving icons onto or away from those active cells.

Turning now to FIG. 5, the internal architecture of the front end 32, and the main program therein, is shown in terms of the functional blocks which are operable at the front end 32.

The front end 32 consists of a main executable program—which acts as the overall “controller” of the front end—and several software building blocks called “components” or “objects”. In a Microsoft Windows implementation of the front end, the main program is a Component Object Model (COM)-aware Win32 executable, and the software “components” are COM components. However, in an implementation of the front end for another operating system and application platform, the actual technologies used may be different, but the architecture will remain the same.

Unlike some monolithic Windows applications, which put together all functionality in a single package, the front end leverages the power, ease of use, and the flexibility of using Microsoft's COM component technology. COM allows the front end to organize functionality into multiple, independent, reusable software building blocks called “components” or “objects” (Note: although there is a difference between these two terms—a “component” is made up of one or more “objects”—the two terms are used interchangeably herein). Each of these components or objects encapsulates distinct software functionality, and interacts with other components through clearly defined programmatic interfaces.

The front end 32 is similar to conventional Microsoft Windows applications in that it adheres to the visual (e.g. menu structure, status bars, buttons, etc.) and behavioral (e.g. right-click behavior, resize behavior, etc.) standards for Windows-based applications. The front end's adherence to these standards significantly eases the learning curve associated with mastering the application's features.

The front end's main executable program controls and manages the lifetimes of the application's various constituent objects—from object creation to object destruction. Furthermore the main program coordinates the operation of the objects, by passing messages between itself and the objects.

The core of the front end however, is in the set of software objects implementing the bulk of the application's functionality. These software objects fall into two categories: (1) graphical objects, and (2) non-graphical objects. Both types of objects encapsulate software functionality, but the graphical objects also display a visual interface. In Microsoft terminology, these graphical objects are called ActiveX custom controls, while the non-graphical objects are called ActiveX components.

The software objects are grouped together, according to functionality, into “layers”. As noted above, there are three layers: (1) the user interface layer 46, (2) the object layer 48, and (3) the communication layer 50.

The most important software object is the grid graphical object 52. It displays Level II quotes in a two-dimensional matrix of multi-colored cells, which it constructs dynamically. The grid graphical object receives its data in real-time (or close to real-time) from a quote server (not shown) which resides on the backend 44; the data however, passes through the object layer 48 and the communication layer 50 first. The grid graphical object 52 also implements the graphical “routing” of orders using a “drag-and-drop” mechanism.

The grid graphical object is hosted inside a container object 54, to facilitate the easy grouping of multiple instances of the grid graphical display, discussed hereafter. The container object 54 is a graphical user interface (GUI) element with the capability to “contain” other graphical objects. An example of a container object is a tab-based dialog object common in Microsoft Windows-based applications.

The order entry graphical object 56 is a compound object (i.e. object made up of several smaller objects) which users of the front end utilize to post an order (and all its associated parameters). The order entry graphical object 56 is also hosted inside a container object 58.

The account and holdings graphical object 60 is another compound object that displays summary and detailed information about an account. This information includes the account balance, order status, account summary, etc.

Each of the three graphical objects described has a counterpart object in the object layer 48. The grid graphical object 52 has a quote source object counterpart 62, which encapsulates the logic necessary for requesting and receiving Level II data from the back-end trading system. The order entry graphical object 56 has an order entry object counterpart 64, which implements the logic and business rules necessary for posting orders to the backend trading system, via the middleware 42. The account and holdings graphical object 60 has an account and holdings object counterpart 66, which implements the logic necessary for requesting, receiving, and updating account information from the back-end trading system.

The communication layer 50 has one or more objects that implement the logic involved in translating requests and commands coming from the upper layers of the front end 32 into the format expected by the middleware 42. This format conforms to the Market Trading Protocol, which is based on XML. The communication objects also translate the data coming from the backend 44, through the middleware 42, into the format expected by the objects in the upper layers of the front end 32. In FIG. 5, there are two communication objects: the Winsock communication object 68, which implements the logic for remote communication using the Winsock protocol, and the SOAP communication object 70, which implements the logic necessary for remote communication using the SOAP protocol.

Other objects 72, 74, 76 may be found on each of the respective user interface layer 46, object layer 48, and communication layer 50, as may be determined by a skilled programmer who is familiar with the present invention.

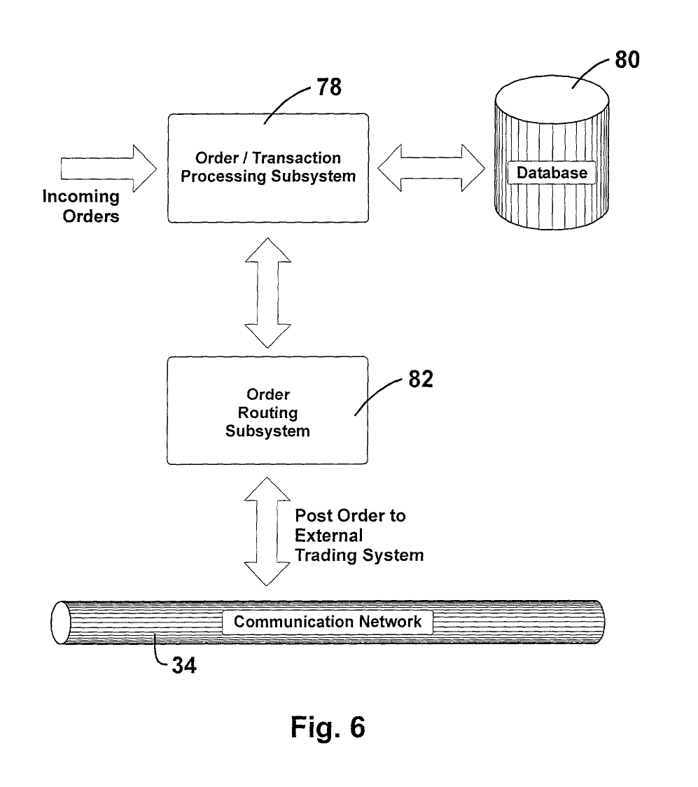

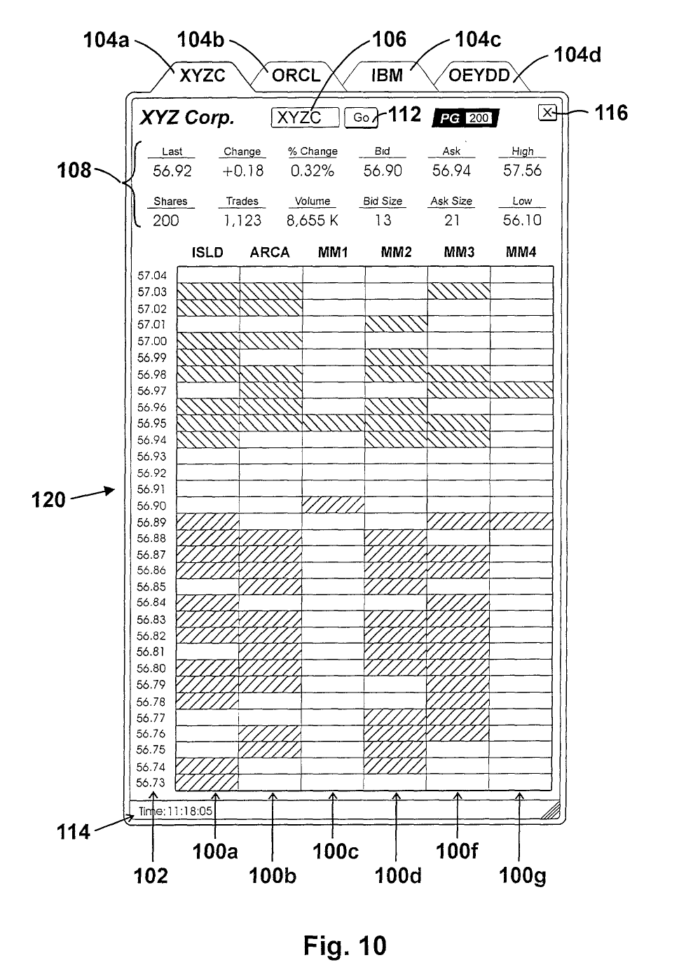

Before turning to a discussion of the graphical display which is presented by the present invention, and as shown in FIGS. 10 to 53, and so as to better understand the purposes and objects of the present invention, its operation, and its functions, several other Figures are presented—FIGS. 6 through 9—and are now discussed in terms of the present invention and the discussion which has gone on before. These discussions are, of course, for purposes of clarity and explanation, and are not intended to be limiting.

Turning first to FIG. 6, there is shown a representation of the order/transaction processing and order routing subsystems of a prototypical backend trading system.

The order/transaction processing subsystem 78 receives orders sent from the front end and records them in the transactions database 80. The subsystem applies appropriate business rules to validate the order and the parameters (such as terms) associated with it.

The order routing subsystem 82 utilizes suitable algorithms and business rules to select the best route for the orders it has received and validated. The best route always directs the order to the market trading participant (a Market Maker or ECN) with the best execution price.

If the user of the front end specifies a route for his/her order, the order routing subsystem 82 will use that route to execute the order. However if the user chooses the automatic routing option in the front end, the order routing subsystem 82 will choose the best route for his/her order.

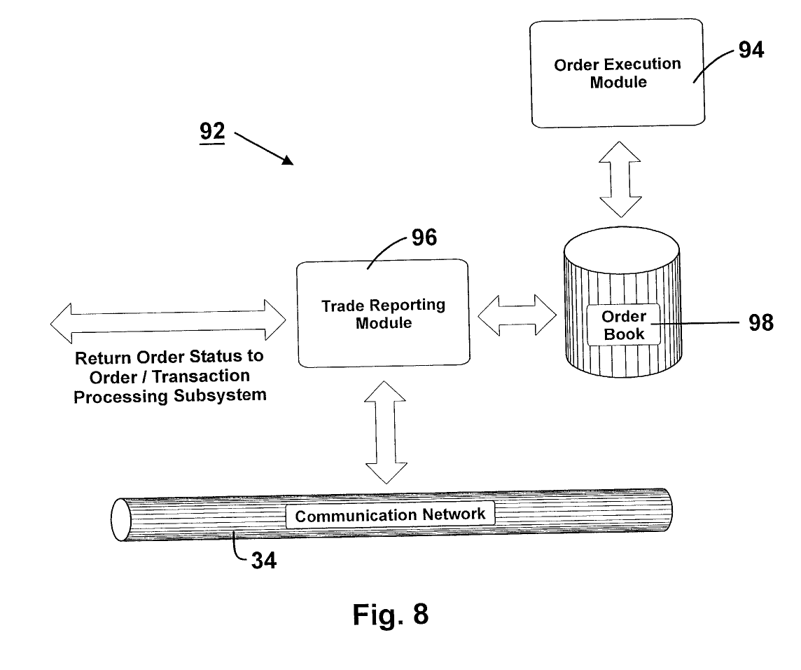

The order routing subsystem 82 communicates with a local order execution subsystem, (if implemented by the backend) and external trading systems to retrieve and compare execution prices available for the an order. The subsystem then uses the price data received to decide where to route orders. The local order execution subsystem is discussed hereafter, with reference to FIG. 8.

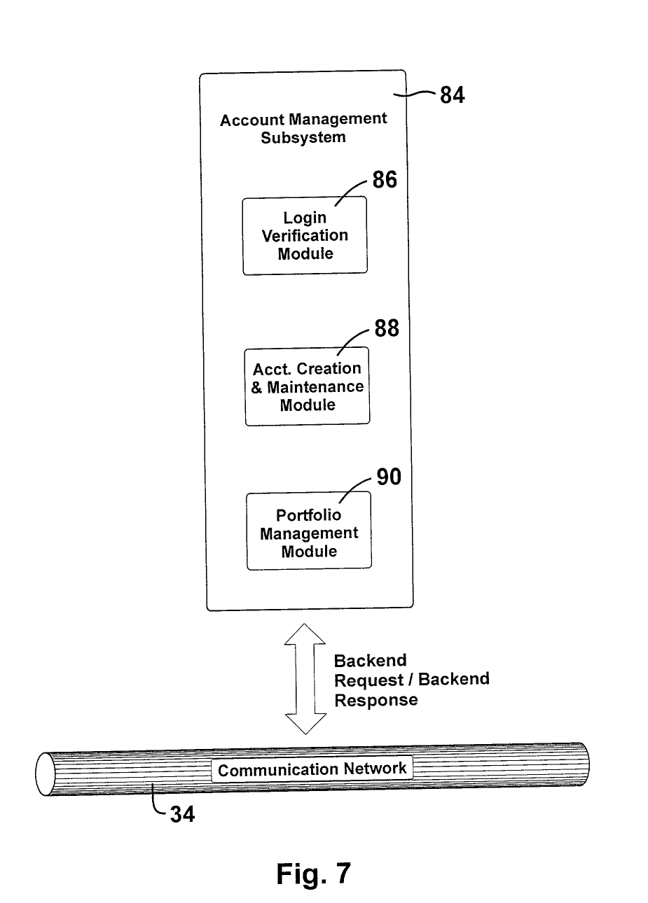

FIG. 7 shows an account management subsystem 84, whose purpose is to handle the creation, monitoring and management of online trading accounts. Before a trader can do online trading transactions, he/she must open an online trading account with an online brokerage firm. There are several types of accounts, depending on the owner of the account (individual or institutional), the purpose for opening the account, and other factors. The account management subsystem 84 manages information pertaining to these accounts and their associated portfolios. It also handles password authentication during the initial login phase.

The account management subsystem 84 consists of three modules: (1) a login verification module 86, which handles authentication of users logging in to the backend system; (2) an account creation & maintenance module 88, which handles the creation, deletion, and management of online trading accounts; and (3) a portfolio management module 90, which handles the portfolios associated with the accounts managed by the account creation & management module 88.

FIG. 8 is a representation of an optional order execution subsystem 92 of a prototypical backend trading system. For Electronic Communications Networks (ECNs), an order execution subsystem 92 is a requisite component, but not for online brokerage firms, which delegate their order execution services to external trading systems.

The order execution subsystem 92 consists of two modules: an order execution module 94 and a trade reporting module 96.

The order execution module 94 handles the automated matching of orders entered in an order book 98. It uses appropriate business rules and matching algorithms to give orders the best price possible at the time of execution. It also implements logic for handling orders with associated special parameters like all or none orders, date/time-dependent orders, etc. This module also handles the cancellation of previously entered orders.

The trade reporting module 96 manages the historical database of all trades executed by the order execution module 94. This module handles requests coming from the other subsystems for trade and execution information.

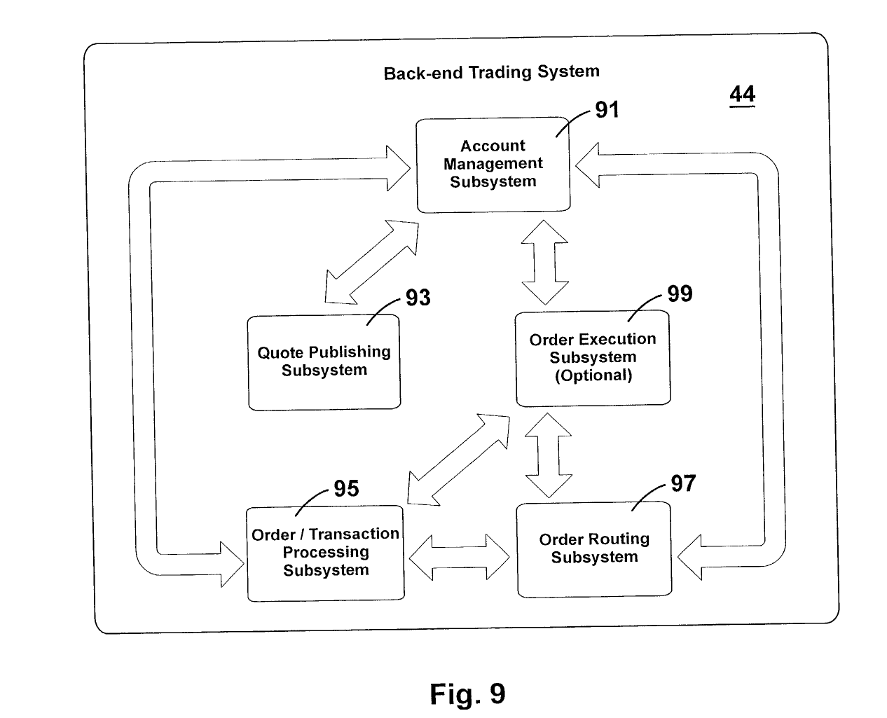

With reference to FIG. 9, a prototypical backend trading system is shown by its functional blocks.

It will be recalled from discussion above with referent to FIGS. 3 and 4, for example, that the front end 32 is capable of interfacing with diverse backend trading systems 44. This includes any system that can: (1) manage online trading accounts, (2) publish quotes (3) receive orders, (4) execute orders, and (5) provide feedback to the trader on the status of his/her orders. The middleware 42, and the Market Trading Protocol, make this capability possible.

Although the backend trading system 44 can be any of the following: an auction system, a currency trading system, or a commodity trading system; the present invention is particularly directed towards securities trading. Thus, this description focuses on a specific type of backend trading system 44. The many similarities between a securities trading system and the other backend trading systems mentioned allow the present invention to be ported from one backend trading system to another, with relative ease.

This discussion with reference to FIG. 9 defines, in general terms, what a prototypical “backend securities trading system” is—its architecture, the processes involved within the system, and the data that is passed back and forth between the front end 32 and the backend trading system 44.

A backend securities trading system 44 is a computerized system operated either by an online brokerage firm or an Electronic Communications Network (ECN). It typically consists of the following subsystems: (1) account management subsystem 91, (2) quote publishing subsystem 93, (3) order/transaction processing subsystem 95, (4) order routing subsystem 97, and (5) order execution subsystem 99.

Furthermore, the implementation of the backend trading system also depends on the type of company that runs it. Online brokerage firms usually implement components 91, 93, 95, 97, but not 99; ECNs on the other hand implement all five components. All backend trading systems 44 however, ultimately link up with a stock market's computerized trading system.

The account management subsystem 91 handles the creation, maintenance and monitoring of online trading accounts. It stores and manages information on the account's owner, its privileges, limitations, balance, its portfolio, and other related information. The account management subsystem 91 also handles the validation of user passwords when users initially log in to the back-end trading system.

The quote publishing subsystem 91, (which may also be referred to as a stock quote server) broadcasts quotes to subscribers. There are two types of quotes: a basic quote which contain information on a stock's last price, the current bid and offer price for the stock, the change in price from the last trade, opening and closing price, highest and lowest price (for the current trading day), and the volume of stocks traded; the other type of quote is the detailed quote, which contains a summary of the prices quoted by different market participants. The detailed quote can also be categorized into two types: one is the detailed quote that comes direct from a stock market like NASDAQ, whose implementation of the detailed quote is called “Level II”. NASDAQ Level II is a tabulation of the top bid and offer prices quoted by NASDAQ Market Makers and ECNs. The other type of detailed quote comes from ECNs and contains a snapshot of the ECN's Order Book (the queue containing all orders submitted to the ECN by its customers, the entries of which are ordered/arranged according to certain business rules). The latter type of detailed quote is sometimes referred to as “Level III”.

The order/transaction processing subsystem 95 receives and validates orders coming from the broker's customers. After validating an order, it applies appropriate business rules (which vary depending on the broker) to the order. These business rules may include, among others, checking the account status of the owner of the order, checking the type and terms associated with the order, etc. Finally, the order/transaction processing subsystem 95 closely coordinates with the order routing subsystem 97 in deciding whether to register or “enter” the order into the local order book 98 (if the back-end trading system has it), or to route it to an external trading system, e.g. NASDAQ or an ECN.

The order routing subsystem 97 uses appropriate business rules and algorithms to select the optimal route for orders accepted and validated by the order/transaction processing subsystem 95. The optimal route directs the order to the best order execution system—the one with the best price, whether it be local (if the backend trading system implements an order execution subsystem 99) or remote (if the backend trading system does not implement an order execution subsystem 99, or it is not the optimal one).

The order execution subsystem 99 matches buy orders with corresponding sell orders. It continuously examines entries in the local order book 98, and then applies certain algorithms and business rules to decide which “buy” orders it will match against a corresponding “sell” orders. This subsystem is tightly linked with the order routing subsystem because the National Association of Security Dealers (NASD) rules dictate that backend trading systems 44 must find the best price possible for all orders it accepts. This subsystem is implemented only by ECNs. Online brokerage firms typically delegate their order execution services to an external trading system like an ECN, or to a NASDAQ Market Maker.

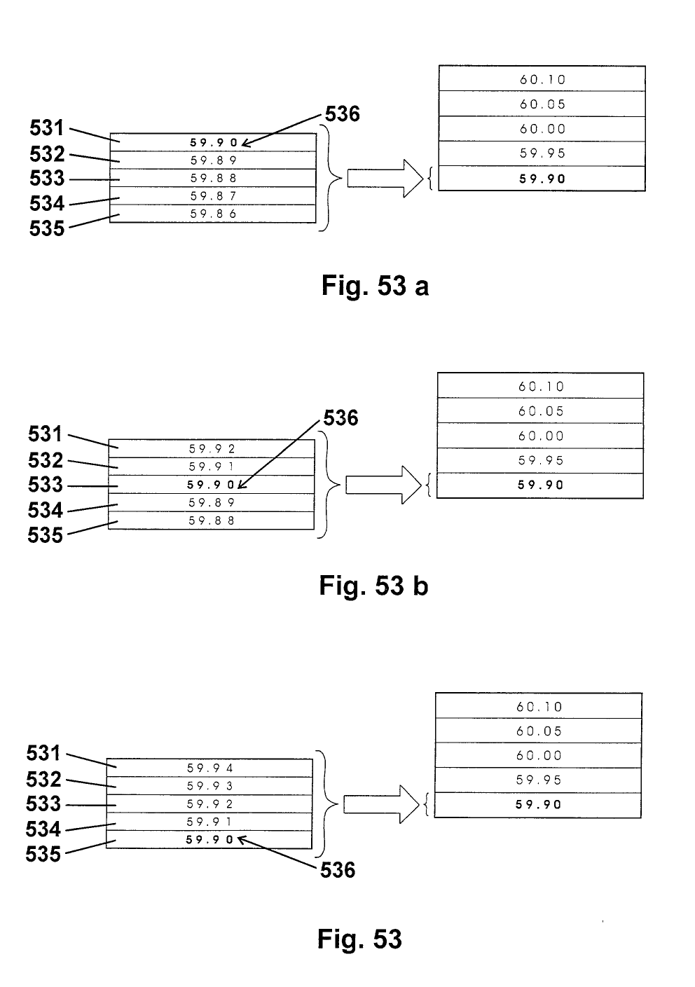

As noted, a particular purpose of the present invention is to provide a graphical user interface which may be used by any trader. Typical graphical displays are discussed with respect to screen snap shots shown in FIGS. 10 and 53, described hereafter.

The front end software of the present invention comprises a set of GUI objects, the operating platform for which is well known.

Thus, a principal function of the GUI front end is to provide a grid representation of market conditions with respect to any security or group of securities, as discussed hereafter, effectively in real-time. The GUI front end also provides a number of other representations or “boxes”, with a number of interactive bins and buttons, and a number of display areas where current data is dynamically updated. A plurality of grids may be shown, as noted hereafter, in side-by-side arrangement, as well as in tabs where once grid is hidden behind another in typical fashion well known particularly to programmers and users of Windows software.

A typical grid is shown in FIG. 10. Here, data for a plurality of market makers are shown in columns 100a . . . 100g (being understood, of course, that the number of columns may vary as may be elected by the user, or as dictated by the software, all as described hereafter). A price axis is shown at 102; in this case, the prices are shown varying in one unit intervals (typically, one cent intervals). Of the tabs 104a . . . 104d, each is indicative of a separate grid for a separate security. Tab 104a has been chosen, so that data concerning a hypothetical security identified as XYZ Corp. is shown. Its stock market symbol is shown at 106. In a grouping of displayed boxes shown generally at 108, specific data is shown concerning the hypothetical corporation. In particular, the price of the last trade at 56.92 is shown, being up 0.18 or 0.32%. The current bid price for this security is 56.90, and the current ask price is 56.94. The highest trade for the particular trading session in progress was at 56.56; the lowest trade was at 56.10.

The last trade was for 200 shares; and there have been 1,123 trades during the current trading session in progress, for a volume of 8,655,000 shares. The bid size and ask size boxes indicate the number of shares being offered for purchase, or the number of shares being offered for sale, respectively, at the current bid and ask prices.

Another box labelled “PG” is shown at 110, and is described hereafter.

What is important to note is that there are a number of cells or price bins which are shown at various prices and in various columns. It is important to note that in FIG. 10, and throughout all of the Figures being discussed herein, active or selected cells for various market makers or other criteria as may be determined for each column, at various prices as shown in the rows thereof, are either bid or ask. The bid prices—that is to say, each bid by any trader which is being made and which is being tracked on the grid, is at a specific price. As noted hereafter, there may be more than one bid at the same price, for any one market trading participant or market maker. In any event, all of the bid prices are shown with a particular hatching in the Figures—upwards to the right. That hatching is indicative of a specific color when the grid is, in fact, shown on the computer screen of a trader, the color being at the election of that trader.

The ask prices are shown with a different hatching—upward to the left—and of course it will be understood that such hatching is indicative of another color which is mutually distinctive from the first color used for bid prices.

Any of columns 100a . . . 100g can be moved to a different location by clicking on the column header and dragging it. They may also be automatically arranged according to some particular criterion, such as the most active market. Other columnar data, particularly aggregate data, are described hereafter.

Box 106 permits entry of a symbol for any given security, after which the button 112 is clicked.

It is possible to adapt the grid display shown in FIG. 10 (and others) for use on Personal Digital Assistant devices or other portable platforms which are capable of displaying graphical information in keeping with the requirements of the present invention.

Buttons may be provided to zoom in or out on the price access 102; a status bar is shown at 114, and a close button is shown at 116.

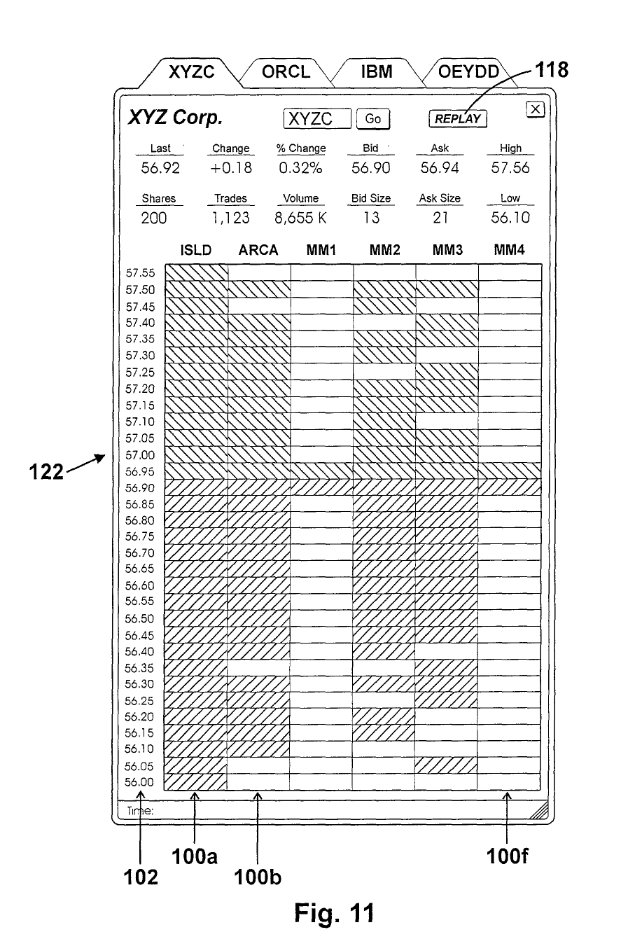

FIG. 11 is similar to that of FIG. 10, showing somewhat different data, because the price access 102 shows each price bin separated from adjacent price bins by increments of 0.05. Thus, while the price range shown in FIG. 10 is from 56.73 up to 57.04, the price range shown in FIG. 11 for the same security is from 56.00 to 57.55.

It will be noted that each price bin or cell in column 100a in FIG. 11 is filled. That is because there is at least one bid or ask offering within each increment shown on the price axis in FIG. 11. For example, while there is no activity shown at prices 56.90 up to 56.93 on the price axis 102 shown in FIG. 10, there is activity shown at 56.94 and 56.95, and thus there is ask activity shown in the price bin at 56.95 in column 100a a shown in FIG. 11.

The details of that dynamic are discussed hereafter, with reference to FIG. 53.

A replay button 118 is indicated in FIG. 11. This replay button can activate an historical data animation which will be displayed graphically on the grid, as described hereafter. Thus, quote and order information for a particular time interval can be reviewed, and accelerated if desired. On particularly active days, market volatility may require that the trader see a wider price range than prices that are merely separated by the security's MPV (minimum price variants). In FIG. 10, the price for XYZ Corp may vary in one unit intervals; thus, each price bin shown in FIG. 11 may hold a multiple of the security's MPV. The replay button 118 will speed up activity so as to gauge the market direction or momentum more accurately. It will allow a trade to compare activity from one period to another; and it will also permit a trader to review market activity that was missed.

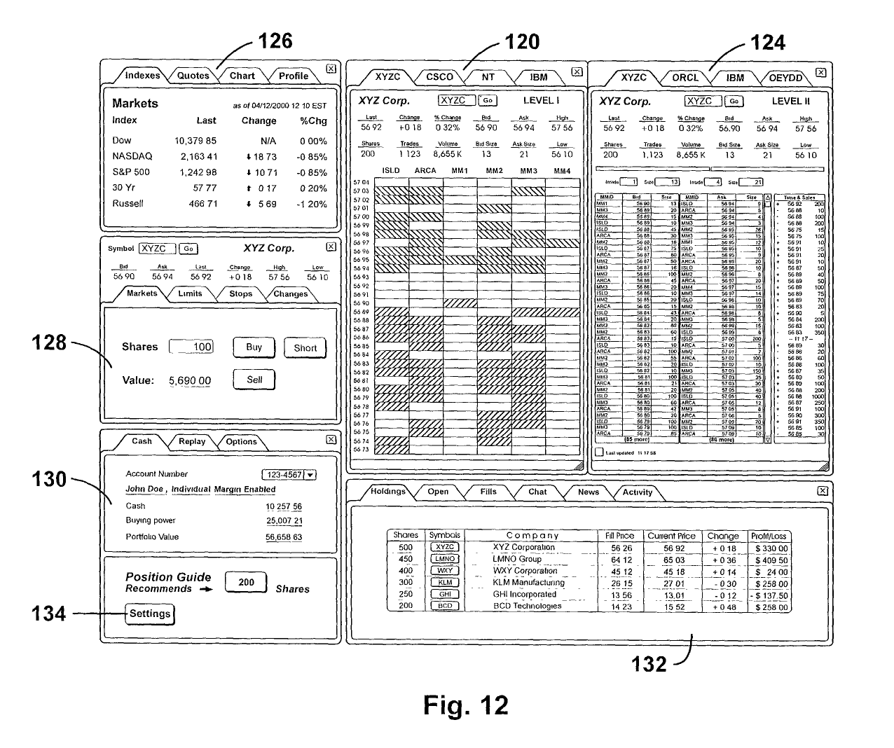

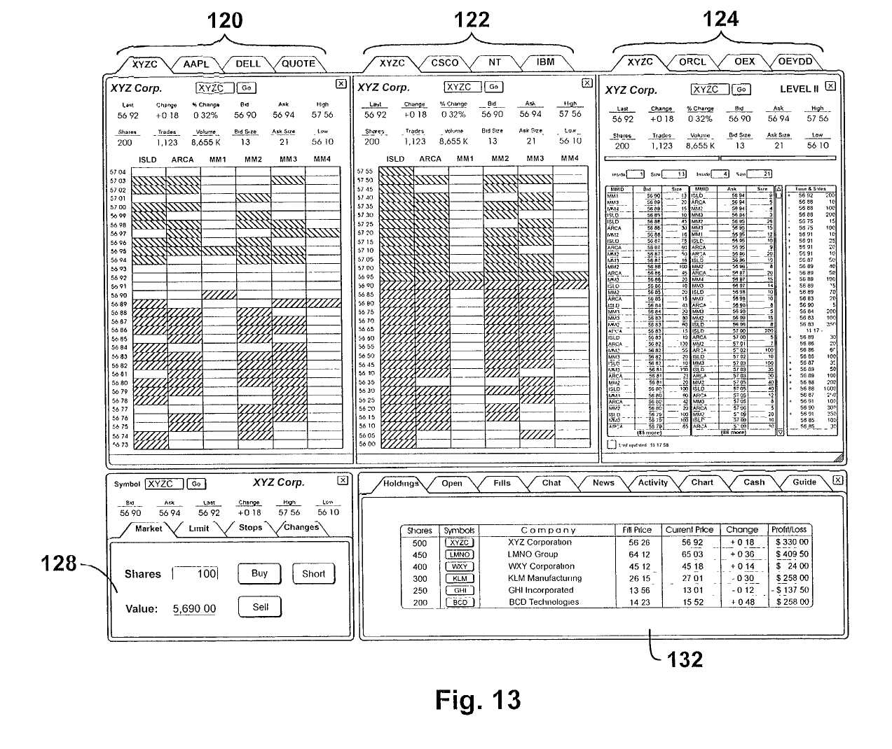

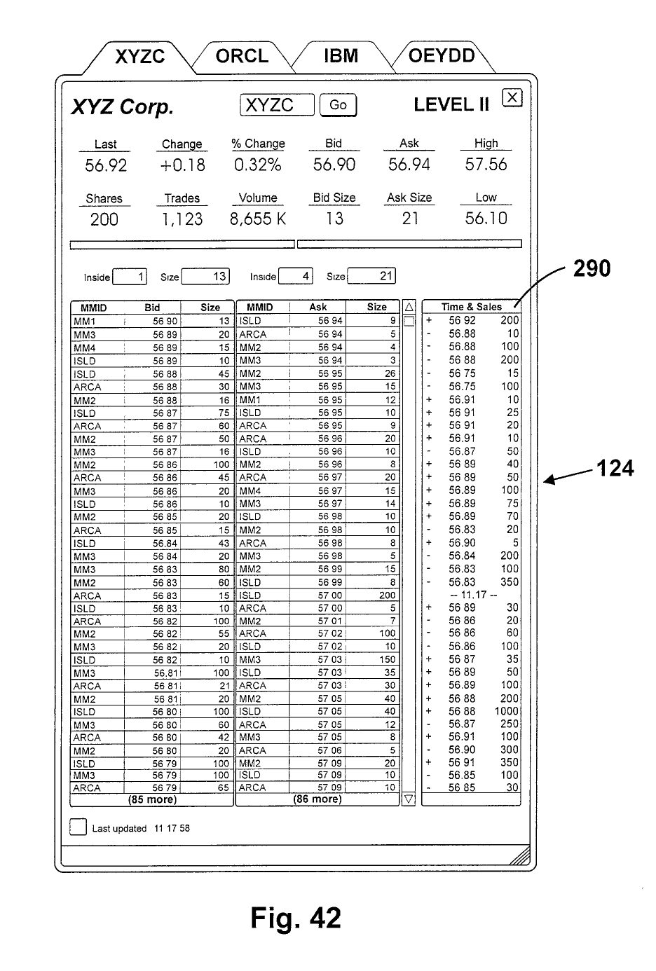

FIG. 12 shows a typical screen shot having a number of specific option boxes down the left hand side and across the bottom, together with two grids 120 and 124, which replicate data shown in FIGS. 10 and 42, respectively. FIG. 13 shows three grids 120, 122, 124 which replicate the data shown in FIGS. 10, 11, and 42, respectively.

Also shown in FIG. 12 are a number of other tab sets 126, 128, 130, and 132. There is also a Position Guide box 134 shown in FIG. 12.

It will be noted that tab set 128 is also shown in FIG. 13, but in a different location than in FIG. 12.

The various tab sets permit the trade to set up and enter orders, monitor open orders, view filled orders, view market statistics, monitor a cash position, recommend shares to purchase, interact with other traders, and follow market developments, all as described hereafter.

Of course, tabs can be moved within tab sets and between tab sets; and may be renamed. Also, as is known in a Windows environment, tab pages can be positioned at any coordinate on the screen, and may dock and undock with other windows, in keeping with Microsoft Windows conventions.

The Position Guide 134 will recommend a suitable level of shares to buy or sell, according to factors such as cash on hand and portfolio value, as described hereafter. A NASDAQ Level II grid 124 is shown, as described hereafter with respect to FIG. 42.

Obviously, the overall look and feel of the user interface may be controlled by a user preference configuration capability. Accordingly, the number of grids that are displayed, the maximum number of windows, the color and design or applications in, as well as other parameters which are relevant to the overall look and feel of the application can be selected, according to the user's preferences and experience.

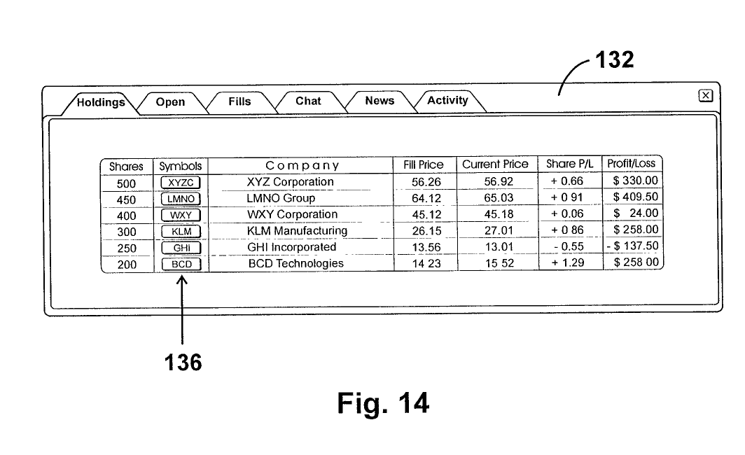

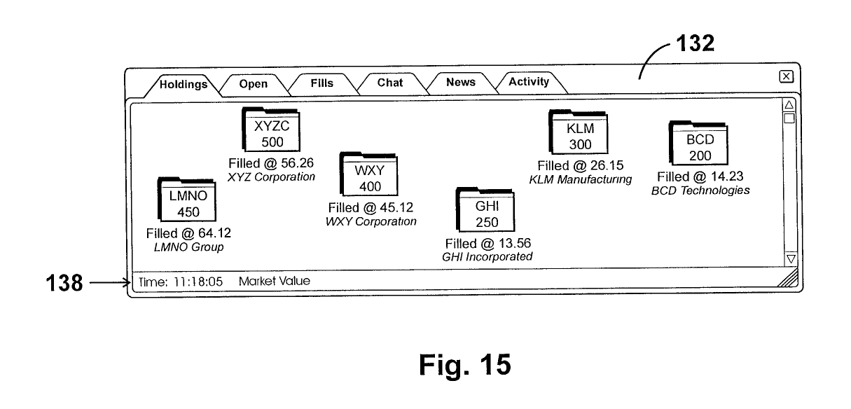

A holdings tab from tab set 132 is shown in greater detail in FIGS. 14 and 15. In FIG. 14, the data is shown in tabular manner; in FIG. 15, it is shown with separate icons for each holding.

The significance is that an icon under the symbols column 136 in the tabular format of FIG. 14 can be dragged into its associated grid for a sale or so as to be covered. Likewise, any of the icons shown in FIG. 15 can be dragged and dropped onto the respective grid.

Examination of FIG. 14 shows that 500 shares of XYZ Corporation are owned; that they were purchased at 56.26 and that the current price is 56.92, up 0.18, for a profit of 330.00. Dollars are shown, but other units might easily be used as well.

From FIG. 15, similar data is shown, but in somewhat less detail.

On the other hand, the icons shown in FIG. 15 may be colored so as to show the type of security or type of order that exists. For example, colors may be used to represent a short order, another color used to represent an option, or a margin purchase, or to indicate profit or loss on individual positions. Each icon may further have data beneath it, which would be revealed by holding a cursor over the icon. The status bar 138 may also display the data, as well as the current market price for the security, if elected.

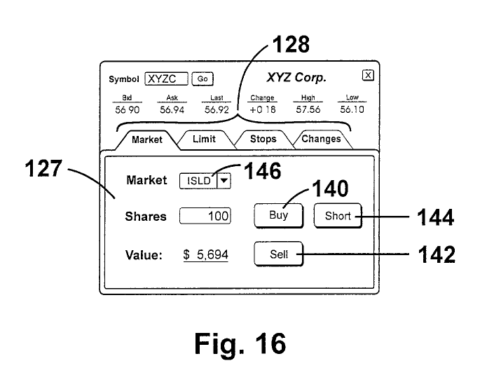

FIG. 16 illustrates a market order entry tab, chosen from tab set 128. This is a form based representation; and it will be noted that there are buy, sell, and short buttons 140, 142, 144, respectively, which can be pressed so as to route an order to a given market. That market may be as shown at 146. Similarly, as can be particularly seen from FIGS. 12 and 13, a buy, sell, or short icon 140, 142, or 144 can be dragged onto the grid 120, for example, for the order to be routed to the selected market—in this case, “ISLD”.

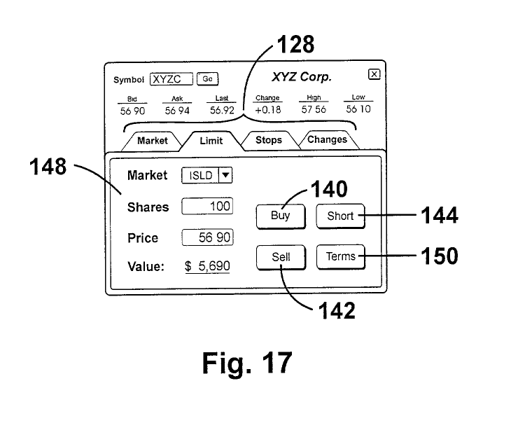

A similar tab is shown in FIG. 17, also selected from the tab set 128; but in this case, it is the limit order tab 148 which has been selected. A further button, the terms button 150, is shown under the tab 148, which permits the order parameters to be adjusted such as the order price and the order volume.

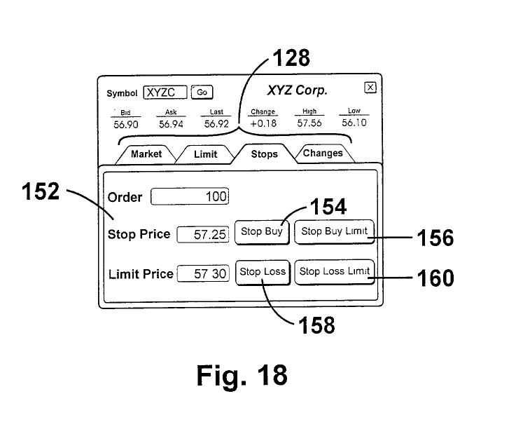

Another tab, tab 152 from the tab set 128, is shown in FIG. 18. That is the stops tab or stop order entry tab.

This tab 152 has similar properties to that of tab 148, except that it is equipped with four other buttons 154, 156, 158, 160 which are labelled as stop buy, stop buy limit, stop loss, and stop loss limit buttons, respectively. An order input can be in terms of shares or an order reference number, so that a filled order can have a corresponding stop order associated with it. Stop orders trigger when a lot has traded at the stop price. When a stop limit order has been entered, a distinction may be shown between the limit price and the stop price, on the respective grid display.

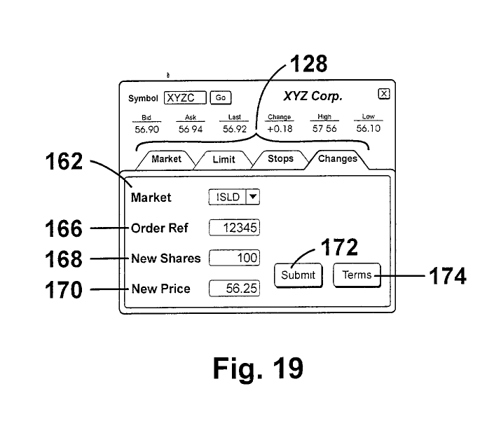

Yet another tab in the tab set 128 is a change order tab 162, shown in FIG. 19. This tab is employed so as to change the parameters of an open order—that is, an order that has already been placed. Here, the order reference number 166 is shown, so as to identify the order which is already in place. The new shares and new price are shown at 168 and 170, with the submit button 172 effecting the change order. Terms may be set by employing button 174.

The significance of this tab is that there is an apparent single step change order instruction which can be effected; when in fact, as noted above, existing systems allow only order cancellations and then the placement of a new order with the necessary changes. However, in this case, the order transaction software will effect the necessary changes simply by activation of the submit button 172.

Changes may be made, of course, in respect of the volume or the price, or even the route through which the order will be placed.

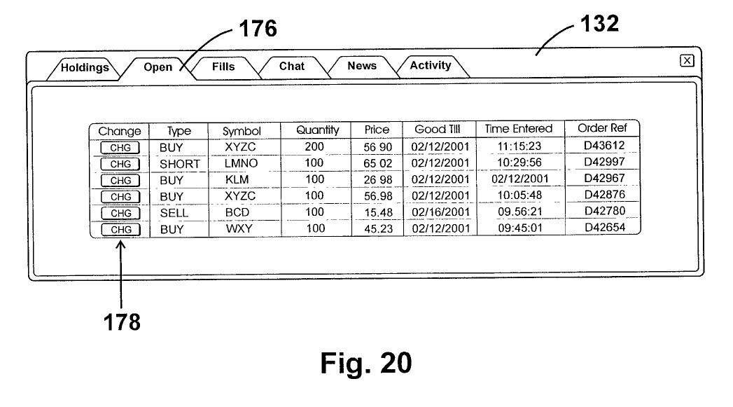

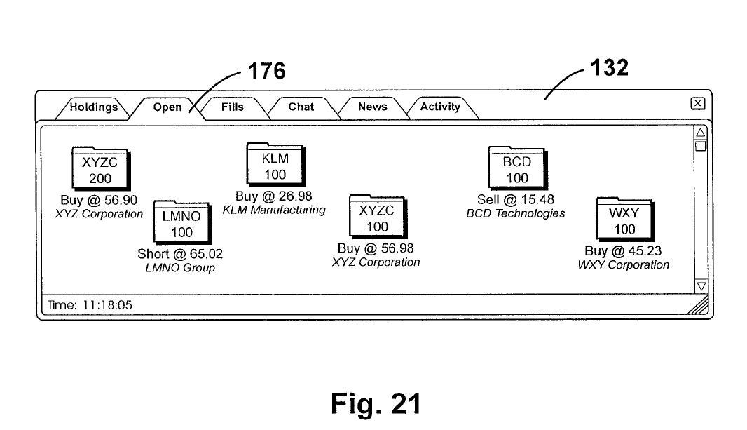

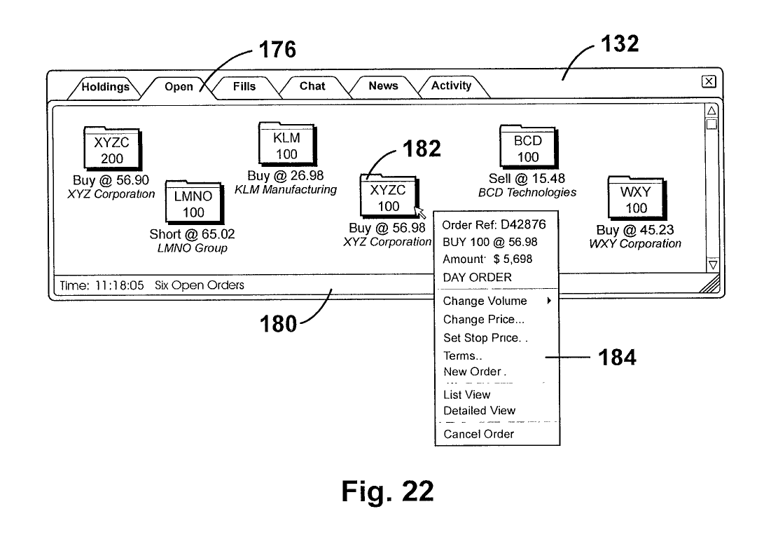

FIG. 20, shows another tab from the tab set 132, namely the open tab 176. FIG. 21 shows similar data, except in icon form; and FIG. 22 shows the same data from FIG. 21 with a further drop-down right click menu.

As described above with respect to FIGS. 14 and 15, there is in this case a change column 178 shown in FIG. 20, which permits order parameters to be changed and which allows the order and the underlying security to be displayed on the grid of FIGS. 10 or 11, for example. The change box can be dragged onto the grid to a specific price bin, so as to effect a price change or to submit an order to a different market.

Again, different colors may be employed to show the type of order—buy, sell, short, etc.

The same data is shown in FIG. 21, but in icon form.

Referring to FIG. 22, the status bar 180 indicates that there are six open orders; and in this case, a right click on icon 182 has opened a drop-down menu 184, which menu permits open order parameters and terms to be changed or cancelled.

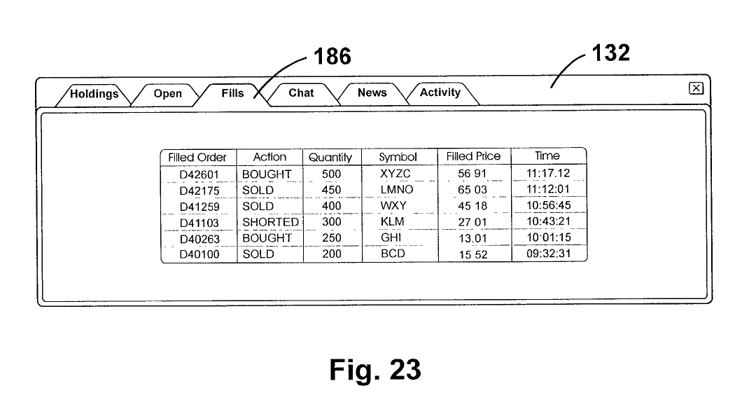

Referring to FIG. 23, another tab 186 from the tab set 132 is shown. This tab 186 reveals data concerning orders that have been filled. Such orders may have been buy, sell, or short—see, for example, FIG. 20—and the data provided in FIG. 23 shows the price and time, and quantity, at which the order was filled or at least partially filled.

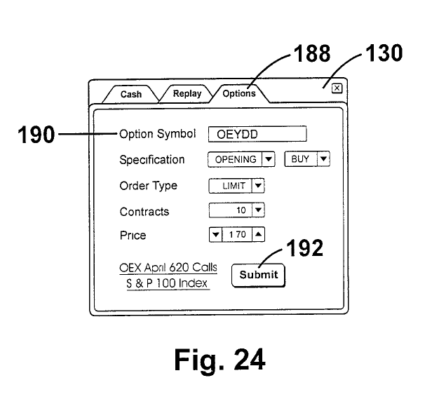

FIG. 24 shows further detail from the tab set 130, in this case being details concerning option orders or other derivatives that may have been placed. Thus, such option orders or other derivatives have their own dedicated order entry tab, with all of the necessary information being entered such as at 190 where a derivative being bought, with additional criteria being chosen as indicated. The submit button 192 will effect the transaction.

Obviously, the submit button 192 may be dragged to a suitable grid so as to enter the order, as will be evident from a review of FIG. 12, for example.

A further drop-down menu may be provided so as to select different market trading participants, for routing of the specific transaction being effected.

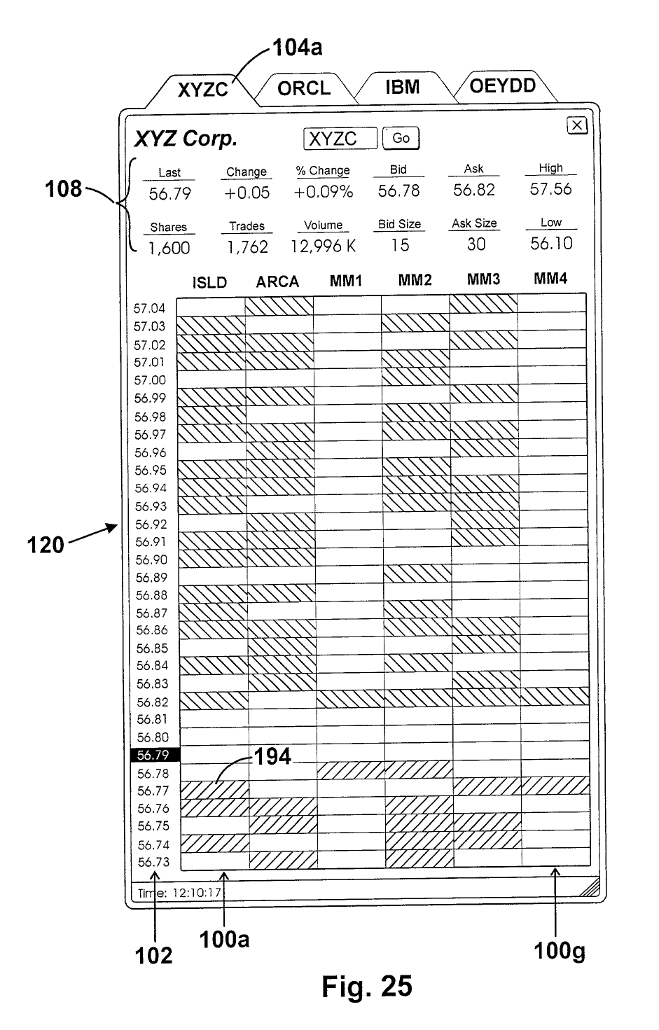

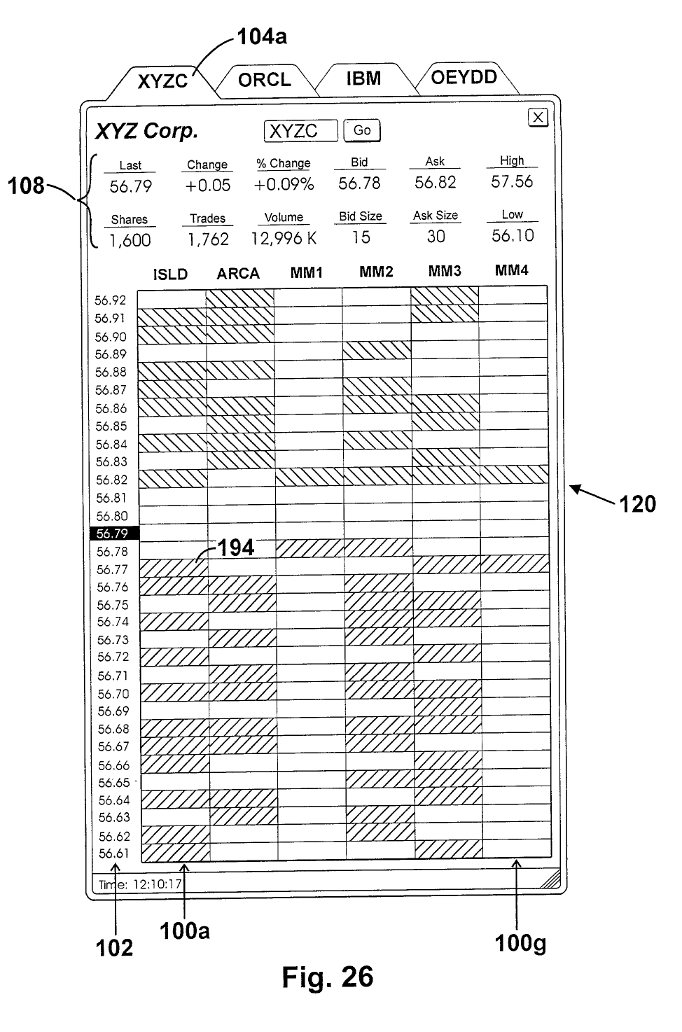

Turning now to a discussion of FIGS. 25 and 26, a typical representation is shown in the case of a falling market.

It will be noted that FIG. 25 is similar to FIG. 10. However, in FIG. 25, the price of XYZ Corp. has dropped from 56.92 to 56.79. As a result, the security is trading down some 13 rows from 56.92. The last trade of 56.79 is highlighted on the price axis 102. The bid and ask of the market participants have fallen to the lower portion of the grid 120, since the price axis is fixed for the 0.01 row increment. If the security trades at or below 56.73, the lowest visible row, the price axis 102 will adjust the displayed price range down to maintain the trading activity in the visible portion of the grid.

The price axis 102 may adjust to trading activity automatically or manually. In automatic mode, it will maintain trading activity substantially centered in the middle of the grid by adjusting the price axis continuously. A smoothing function may be used to prevent the price axis from adjusting itself to quickly in an active market. In manual mode, the user resets the trading activity to the center of the axis 102. A buy order cell—such as cell 194—on a fixed price axis 102 will remain stationary as the trading activity moves towards it and eventually fills the order.

When a security is first shown on the grid 120, the user may elect to position the price axis 102 according to the session high, low, opening, or last trade prices. Alternatively, the price axis 102 can be centered to the closing price of the previous session, or a technical indicator such as the 50 day moving average.

FIG. 26 is similar to FIG. 25, except that the price axis 102 has been centered on the grid 120. A buy order cell 194 on a centered price axis will appear to climb higher towards the trading activity as the price of the security falls, until eventually the order is filled. A right click menu on the price axis 102 can select how the price axis reacts to price variations in the security.

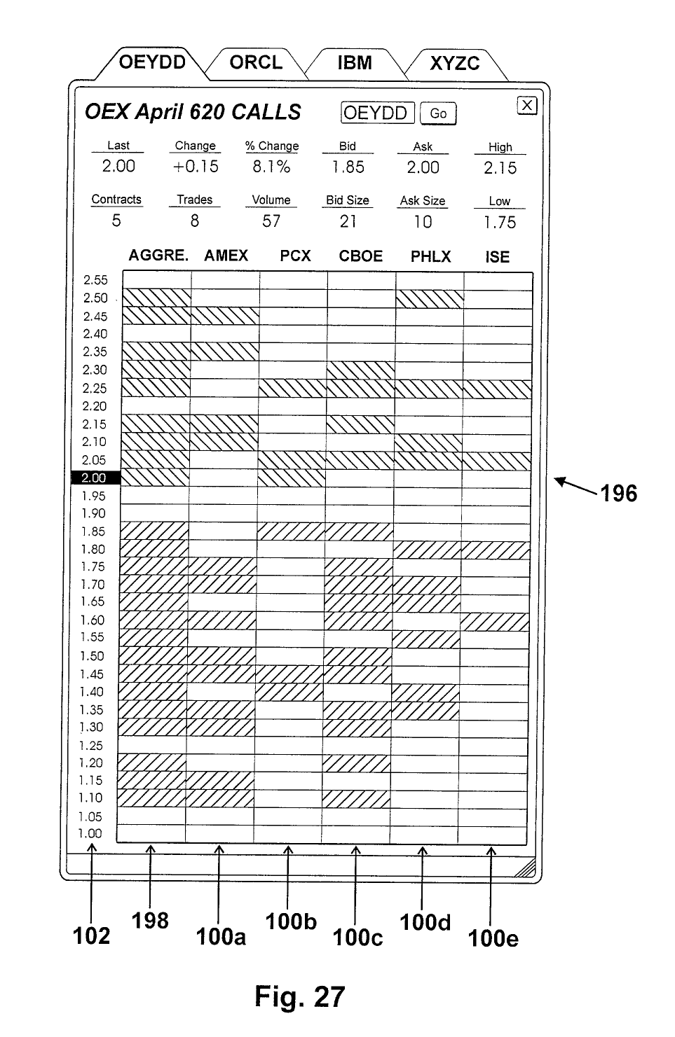

Turning now to FIG. 27, there is shown a grid representation in which an aggregate price column or an option series is illustrated. Here, the grid 196 shows an option series representation for particular options of a security—in this case, call options.

In this case, the price axis 102 is in 0.05 increments as is suitable for an option priced under 3.00. There is also an aggregate column 198 which displays the aggregate or combined markets with all available buyer and seller prices and order size. Orders placed in the aggregate column may be routed automatically to the market that contains the best price or fastest executions.

Some users may not be interested in viewing quote activity in all available markets, as shown in columns 100a . . . 100e, and may choose to view and enter orders only in the aggregate column 198. Options symbol are entered into the grid 198 directly, or via the options entry tab 188 (see FIG. 24).

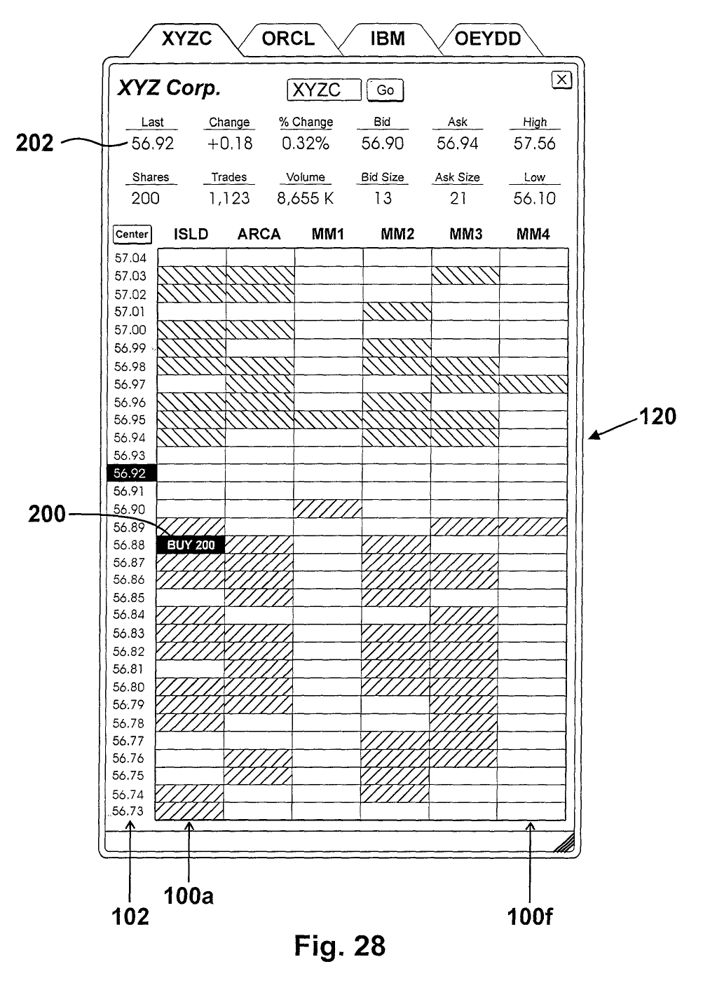

Turning now to FIG. 28, a representation of a limit buy order is shown. The data shown on the grid 120 of FIG. 28 are the same as those shown in FIG. 10.

FIG. 28 demonstrates how a buy order 200 is located on the grid 120. The buy order for 200 shares of XYZC is a limit order placed at 56.88. This is 0.04 below the last trade price on XYZC, as shown at 202. The market where the order is placed is Island ECN, as noted in the header for column 100a. To distinguish an order from the background quotes, a contrasting texture or color is used. The text inside the order also helps identify the type of order and shares being sold. In a similar manner, a limit sell order may be placed in a suitable market and in the upper portion of the grid representing seller quotes.

The order is placed on the grid 120 in a number of ways. First, the order will be entered automatically into a suitable grid if it is submitted from an order entry tab such as that shown in FIG. 16. Second, the order can be entered or drag and dropped from the Position Guide 134, which recommends the amount of shares to purchase as well. Third, the order can be dragged and dropped from the holdings tab, as seen in FIGS. 14 and 15, or a similar status tab.

The orders can be posted to the grid direct from the appropriate entry method, either through the order entry tabs or the Position Guide, with validation to follow; or the orders can be posted after validation from the exchange or market. In the latter case, a delay may occur between the time the order is entered and the time it is validated. In this case, the cell 200 may indicate a non-valid status until the backend system validates the order.

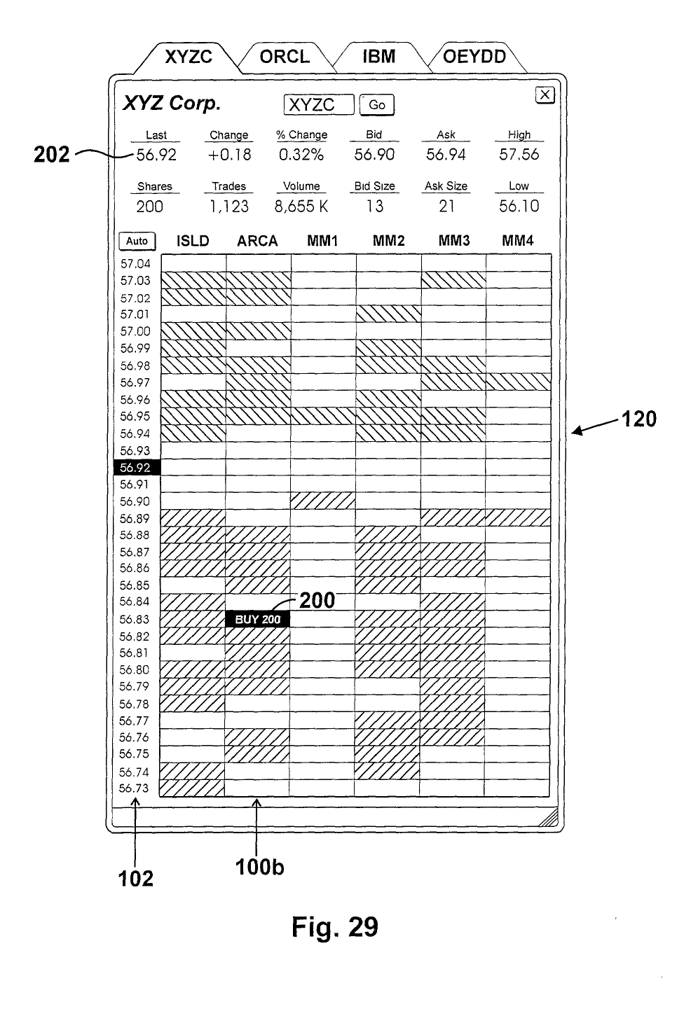

FIG. 29 is similar to FIG. 28, except in this case the order 200 has been routed from one market to a different market at a different price. The original order has been routed to Archipelago ECN in column 100b, and the buy price has been reduced to 56.83. This apparent order change occurs when a selected buy cell 200 is dragged or routed by the computer's pointing device, such as a mouse or a keyboard cursor arrow, such that the selected buy order cell 200 moves left, right, up, or down, along the grid. The practical affect, from an exchange or market makers perspective, may be to cancel one order, and enter another in a different market, or to change (CFO) one open order to reflect an adjusted price, volume, or other order parameters or terms. This routing of orders between markets, and changing prices graphically, is at the heart of the grid's function.

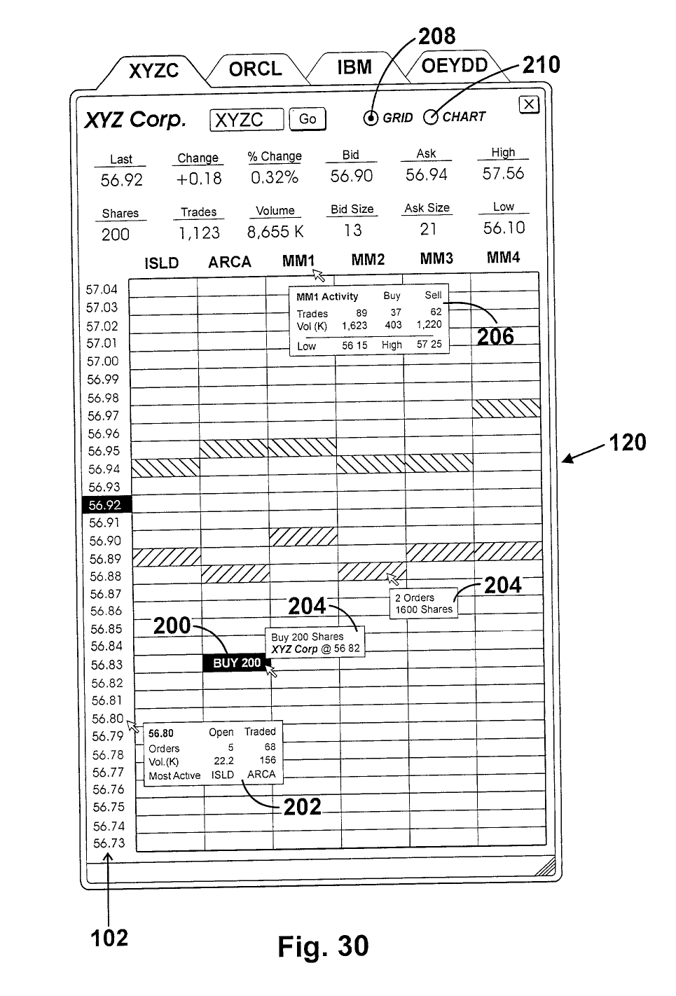

FIG. 30 is similar to FIG. 10. However, in FIG. 30, only the bid and ask for each market is displayed. The buy order 200 from FIG. 29 remains visible. Some users may prefer this view, selected from the grid preferences menu, as it removes movement outside the market and makes open orders stand out.

FIG. 30 also shows an example that a mouse has over effects on quote cells 202, orders cells 204, and row and column headings 206. At the top of this view, a radio button 208,210 shows that the tab page can toggle between a grid display of XYZC and a chart of the security.

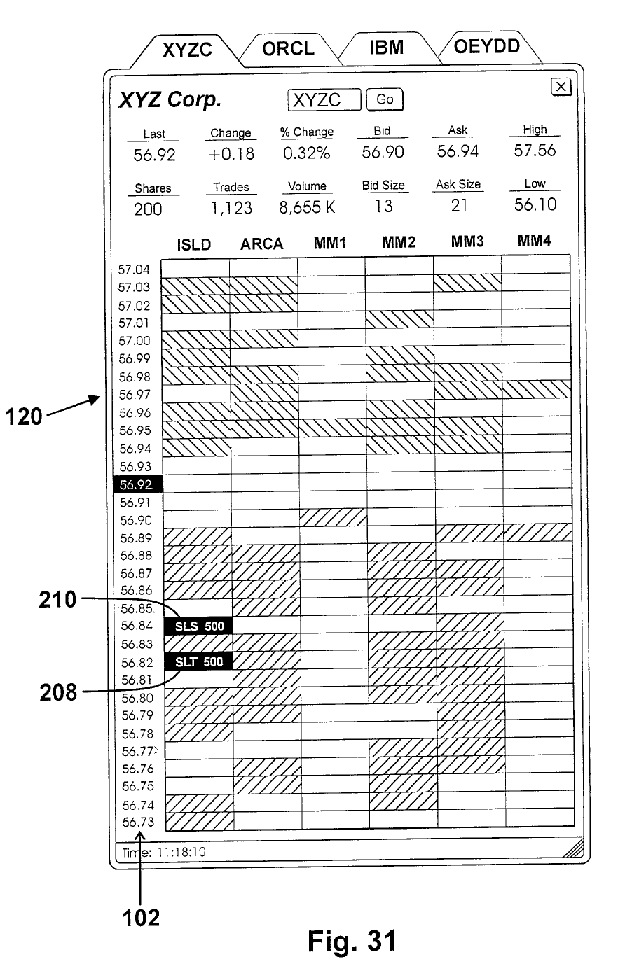

FIG. 31 shows a stop loss limit order 208. In this example, the stop price is 56.82. When one lot of the security has traded at the stop price, the associated limit sell order 210 becomes active. Both parameters, the stop price, and the limit sell price, can be changed by dragging its associated cell. Text inside the order cells help identify the order type, quantity, and function.

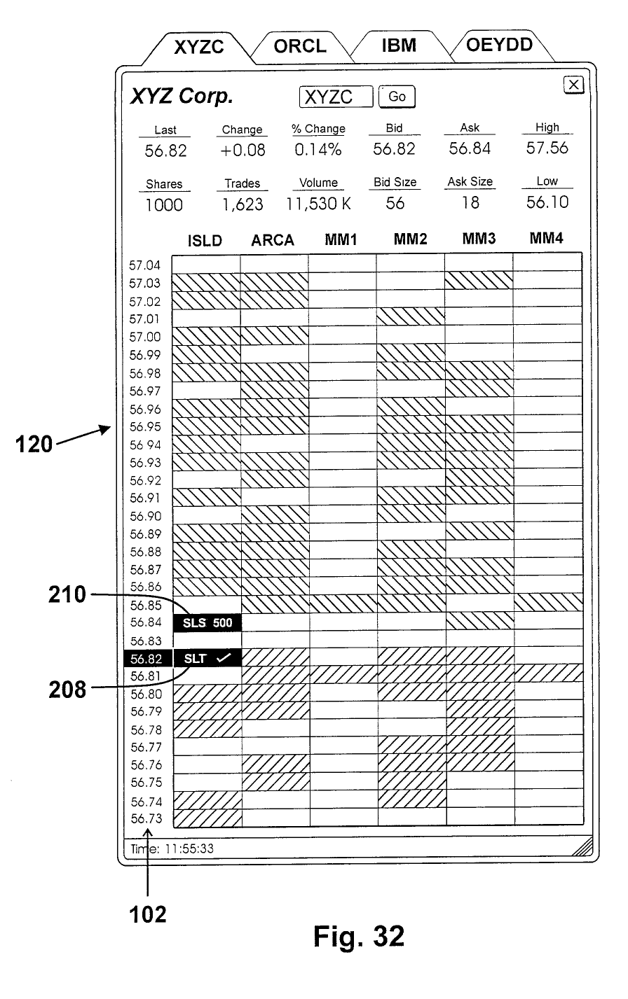

FIG. 32 is a representation of FIG. 31, once the stop price has been reached and triggered. In this view, the stop price 208 of 56.82 remains on the grid 120 to show that the stop price has been triggered and the limit sell order 210 is now an open order. The limit price may be changed while the order is open. In this manner, more complex order types may be displayed.

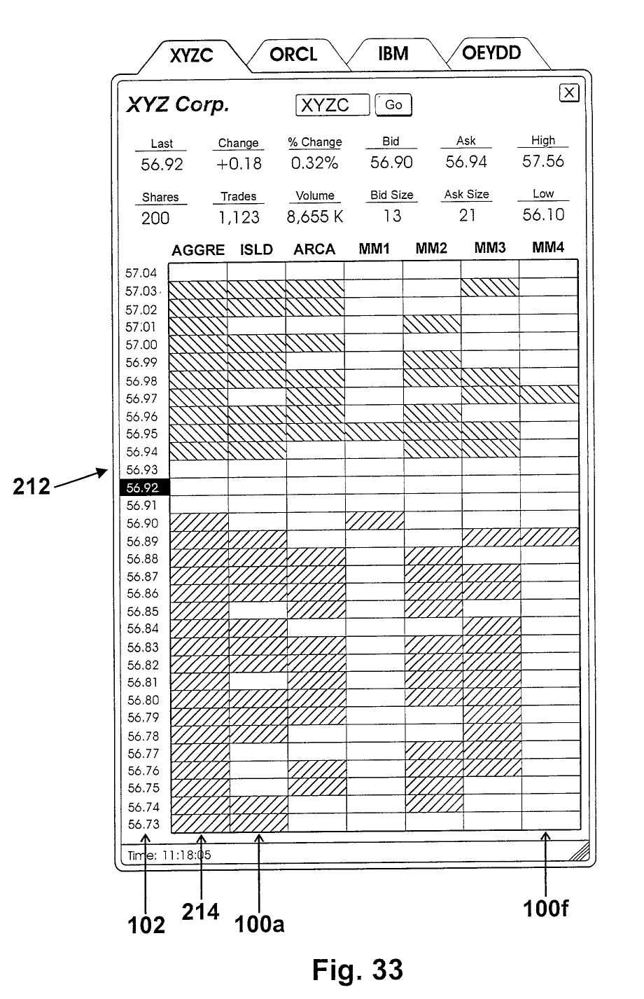

FIG. 33 is somewhat similar to FIG. 27, and in this case it shows a grid 212 for a security, XYZ Corp., which trades in multiple markets, being represented by an aggregate column 214. The aggregate column combines all orders and order quantities from each selected market 100a . . . 100f into a single column. The aggregate column 214 may represent, for example, aggregate quote data from those markets available to the user's brokerage firm to trade on and to submit orders to. The grid's price axis 102 may also be split into two sequential price series to show different price ranges for the same security.

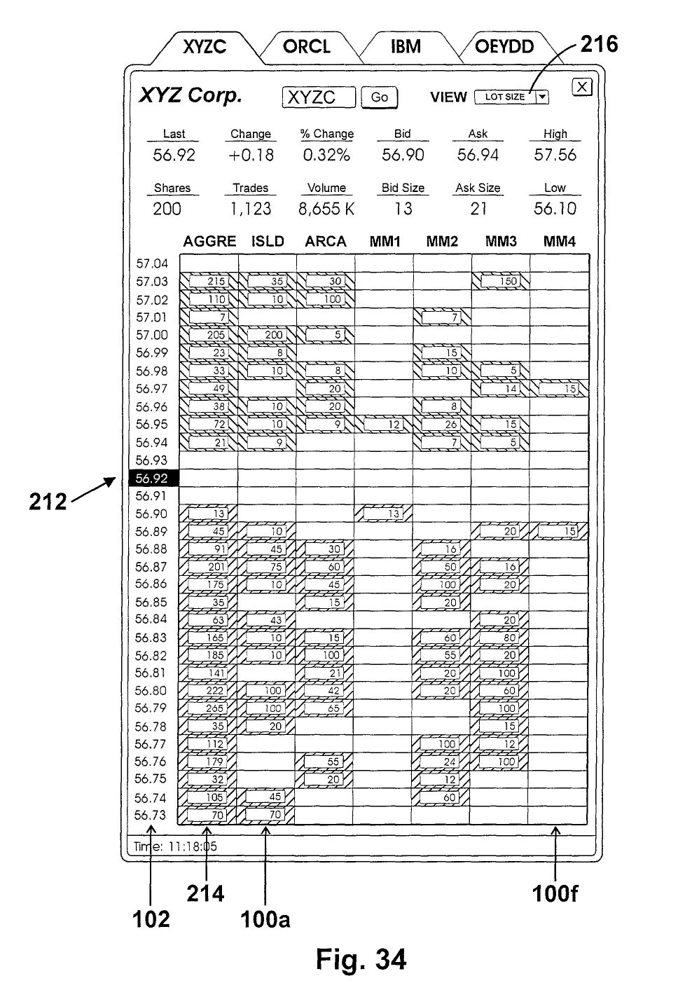

FIG. 34 is a representation of FIG. 33, having the same data, but with each cell which contain a market quote having a text display of a cell property. A drop down menu 216 is presented at the top of the page tab for selecting the property. In the preferred embodiment, the text shown on each cell can be total lot size, orders, trade value, or share quantity open and available inside the cell. Similarly, the total lot size, orders, trade value, or share quantity filled or executed at each cell can be shown over a period of time. In the latter case, the length of time specified may be from the beginning of the current session, during the past hour, or a user selected time interval. The aggregate column 214 may also contain text summary data.

In addition to a text inside the cell, colors and color gradients can be used to display the same parameter or an alternative parameter of each cell or order.

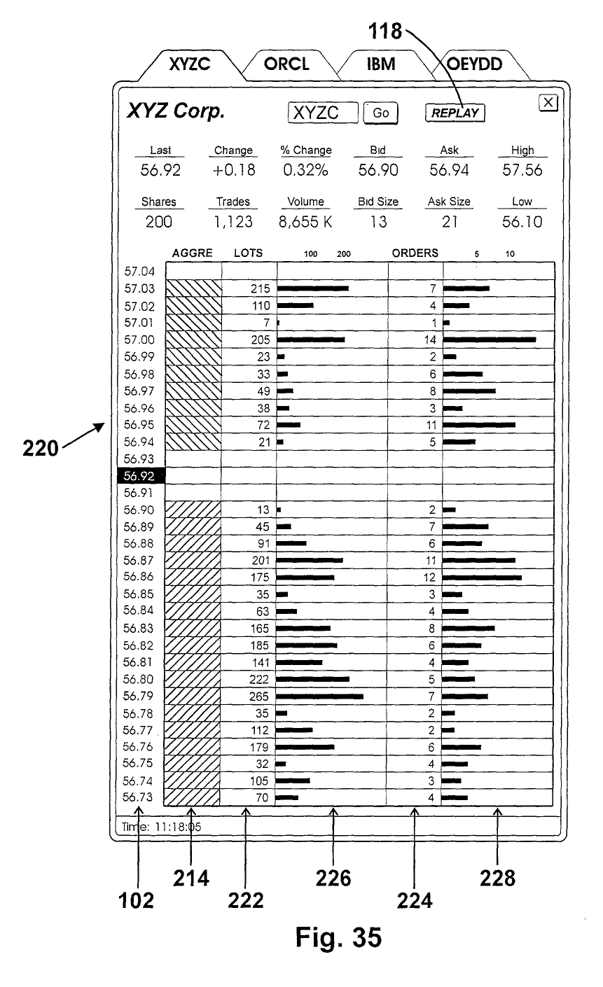

Turning now to FIG. 35, a grid 220 is shown, which uses the concept of the aggregate column 214 to show a one column view of the market. The remaining columns 222 and 224 are used to show lot size and order quantity for each price increment. A graphical representation of lot size and order quantity is shown next to the text data, at 226 and 228, respectively. A replay button 118 is shown, which can animate historical data in a graphical presentation. A right click menu is available over the column name to allow the user to select a data display from specific markets rather than an aggregate representation. For example, the grid column 214 can represent data only from Island ECN and display the corresponding text 222, 224 and graphical 226, 228 representation of lot size and order quantity, respectively.

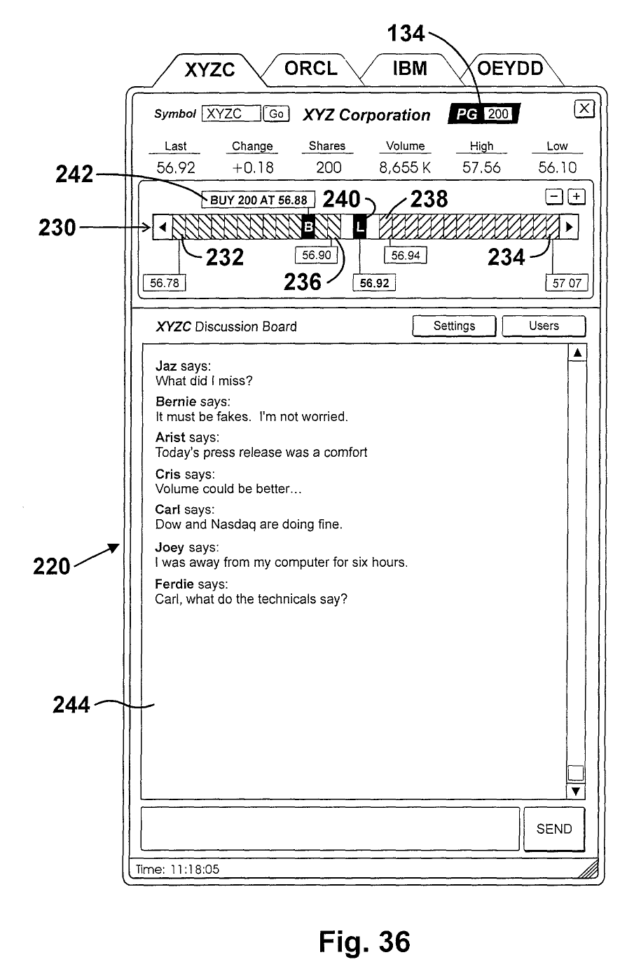

FIG. 36 shows the market column or aggregate column 214 of FIG. 35 rotated 90 degrees, and now presented horizontally at 230. Price increments run along the x-axis from left to right. The rightmost cell contains the highest price value. The size of each price bin may be increased to view a larger price range for the security. Direction buttons at each end of the grid allow the grid's price axis 230 to be scrolled left or right. The cell values at the endpoints 232, 234, the bid and ask 236 and 238, and the last trade 240, are all indicated and linked to their representative cell. Open orders are also shown, in this case at 242, above the grid.

A Position Guide 134 allows orders to be dragged and dropped onto any cell that is displayed. In this type of display, the bid is shown on the left, and the ask is shown on the right. There is less room to display text inside each cell in this implementation of the grid 220. As a result, buy orders 242, the last trade 240, or a sell order, may be represented by the single letters “B”, “L”, and “S” within each cell. These cell types may also be represented by specific colors as well.

Under the grid 220, a chat application 244 allows discussion of a selected security or topic. The integration of the chat application on 244 the same tab page allows a security to be monitored closely while a discussion is ongoing.

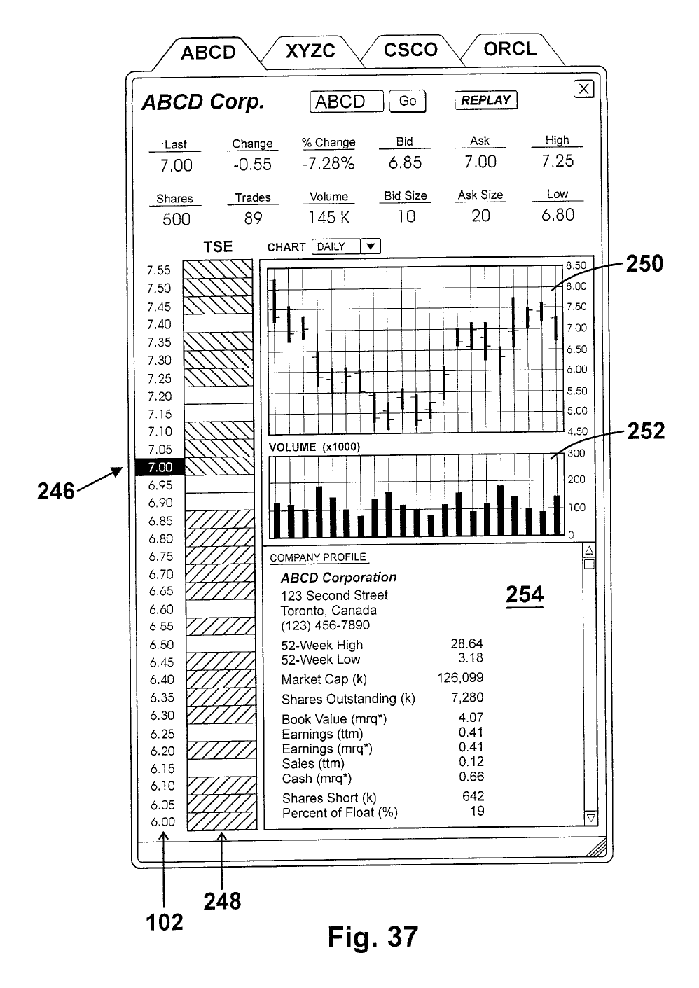

FIG. 37 shows a single column representation of a grid 246. Single column representations are appropriate whenever listed securities trade and are quoted in only one market such as the Toronto Stock Exchange. Those quotes are shown in column 248. The remaining space on the tab page is taken up by charts 250, 252 and a fundamental profile data 254 on the security. A drop down menu allows the chart type and time interval to be selected.

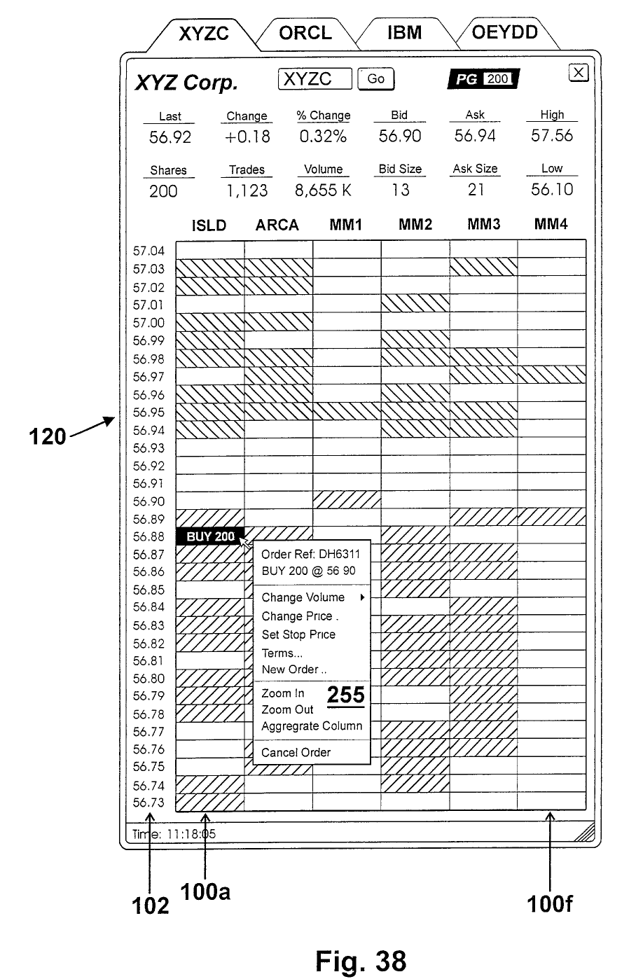

FIG. 38 is similar to FIG. 28, with a representation of a right click menu 254 on the buy order. The right-click menu 254 is location and context sensitive, and allows the user to view order statistics, change order parameters, adjust price bin size, set preferences, display an aggregate column, and undo a change. The right-click menu 254 also allows the user to access the Position Guide 134 and the replay feature 118 of the grid interface.

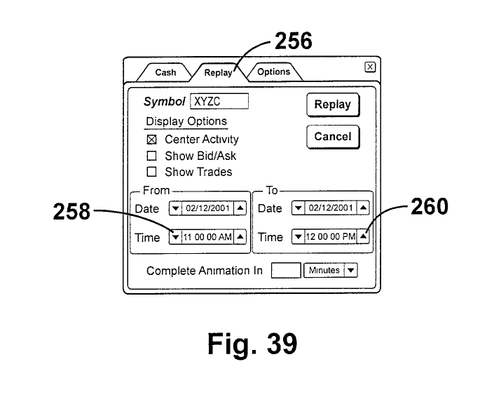

FIG. 39 is a representation of the replay settings tab 256. The replay feature 118 provides a graphical payback of historical data and trading activity on a grid. If the historical time interval being reviewed is large, the playback interval can be accelerated. For example, if the historical interval being reviewed was originally 60 minutes long, as cam be seen by comparing the times for the start and end of the interval to be displayed, as set at 258 and 260, the user can adjust the animations time period to view this interval at 10 times normal speed which would result in the animation lasting six minutes. Similarly, the animation interval can be fixed for a defined time, for example, 2 minutes, without regard to how long the original historical time interval was. If the historical data or necessary file on the security is not resident on the user's computer, it may be downloaded from a suitable server. The replay application 118 uses actual historical quote data to run the animation. The replay feature 118 works only if there is archived (historical) quote and order data.

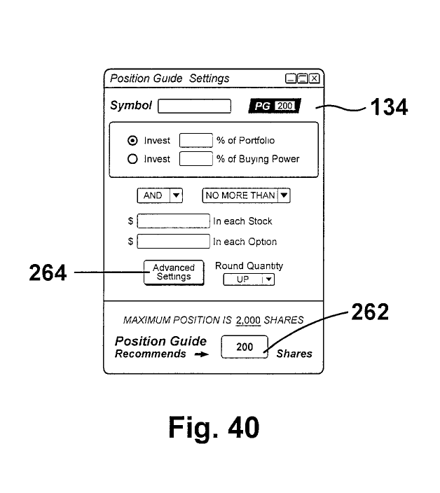

FIG. 40 is a representation of the Position Guide 134 settings. The Position Guide 134 recommends a quantity of each security to buy or short, based on input from the user on the amount of funds to be invested in each type of security, and the percentage of buying power or portfolio value available to be invested in any trade. Recommendations are rounded up or down to a standard lot size or contract size, as shown at 262. The recommended quantity to be purchased or shorted can be dragged from the Position Guide icon 134 to an appropriate cell on any grid, for the corresponding security. The order can also be initiated directly on the tab page of each grid by electing to show the Position Guide icon 134 on each tab page.

Advanced settings 264 on the Position Guide tab 134 give access to timing tools so that trades that appear technically sound bias the Position Guide to recommend a higher quantity of the security than trades that appear to have poor or no technical merit.

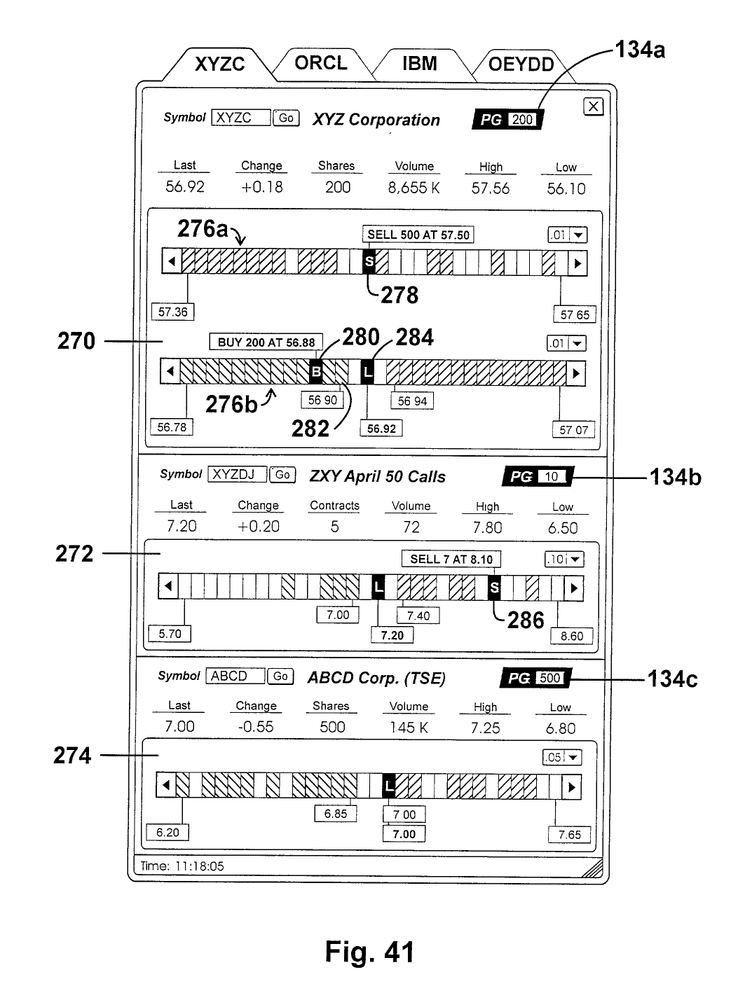

FIG. 41 shows horizontal grids 270, 272, 274 for three securities. Each security has its own grid 278, 280 and Position Guide 134a, 134b, 134c, respectively. The top security, XYZ Corp, has two grid rows 276a, 276b associated with it. Each functions independently and provides a display of the security in its own respective price range. Orders 278, 280, bid 282, ask, and last trade information 284 can be indicated on both related grids if the price labels overlap. Each grid allows the price bin to be adjusted independently of the other.

The middle security is an option series. The Position Guide 134b recommendation is based on contracts, not shares. Options above 3.00 trade in MPV of 0.10 increments. There is a sell order 286 at 8.10.

The bottom security, ABCD Corp, is being monitored by the user, and has no open orders associated with it.

Turning now to FIG. 42, there is shown conventional NASDAQ Level II display 124, as used by day traders in the US equity markets. Time and sales information is on the right side of the display at 290. Since, the grid representation of trading and quote activity differs from the NASDAQ Level II view, traders new to the grid view may prefer to additionally monitor securities with Level II displays. To accommodate this need, the tab pages of the grid area can switch between NASDAQ Level II views and Grid based views of the trading activity.

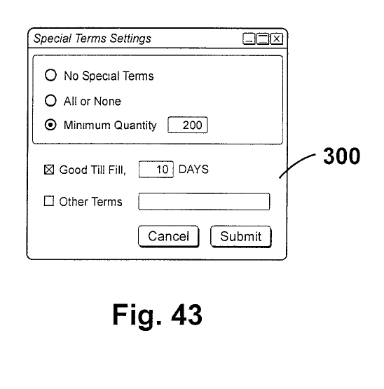

FIG. 43 shows a representation of the special terms setting dialog box 300. Special terms dictate how the order must be filled. Setting special terms is a common feature of trading applications. Special terms for an open order may be accessed and changed from the right-click menu of an order cell on any grid.

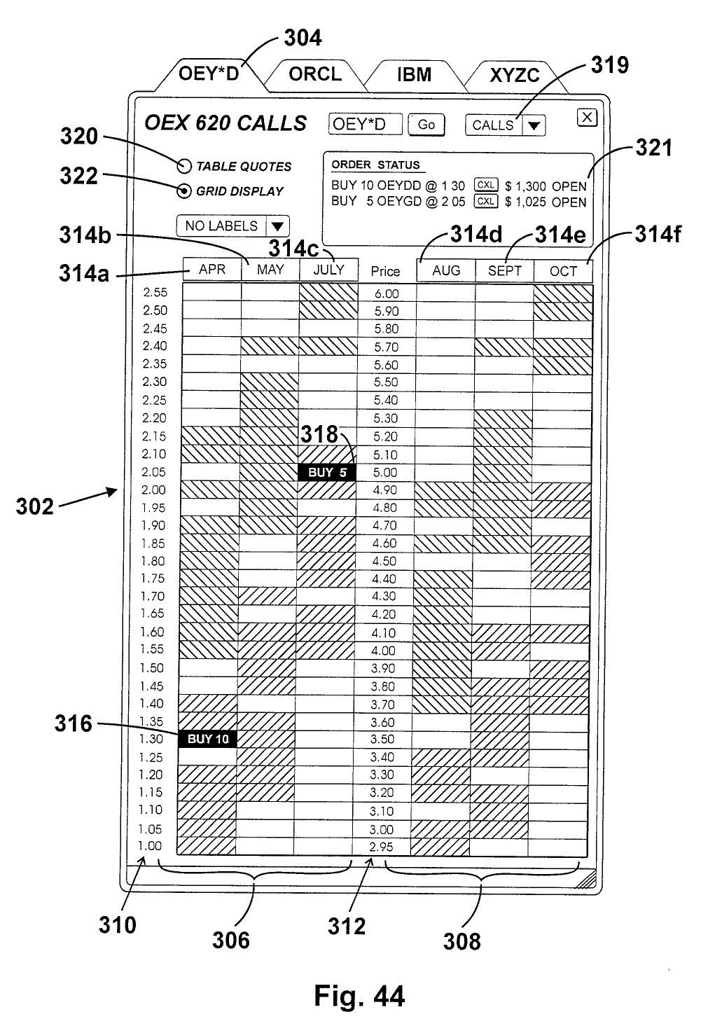

FIG. 44 shows a representation of an option chain on a grid 302. The tab name OEY*D, shown at 304, indicates an option chain. The symbol arranges the grid to fit the data from the option chain. There are two grids 306, 308, each with their associated price axis 310, 312, respectively. Bid and Ask prices are displayed for various months, in columns 314a . . . 314f, at different price levels. Two buy orders 316, 318 are indicated. The first is to buy 10 contracts of the OEX April 620 calls at 1.30. The second to buy 5 contracts of the OEX July 620 calls at 2.05.

The grid drop down menu 318 allows data for puts, call, or both classes to be displayed. An order status area 320 allows the user to monitor the status of the open options orders. The option order prices can be changed, by dragging the order cell up or down its respective column. The radio buttons 320, 322 allow the option quote data to be displayed in a table style, or on the grid. Standard preferences may be applied such as showing contract size in each cell. Only the bid and ask of each month's data may be selected as well to reduce the level of detail. Alarms can be set to warn the user of a change of status or trading activity.

Each column contains aggregate data combined from all available markets. However, a single market, such as the CBOE, may be viewed on the grid as well.

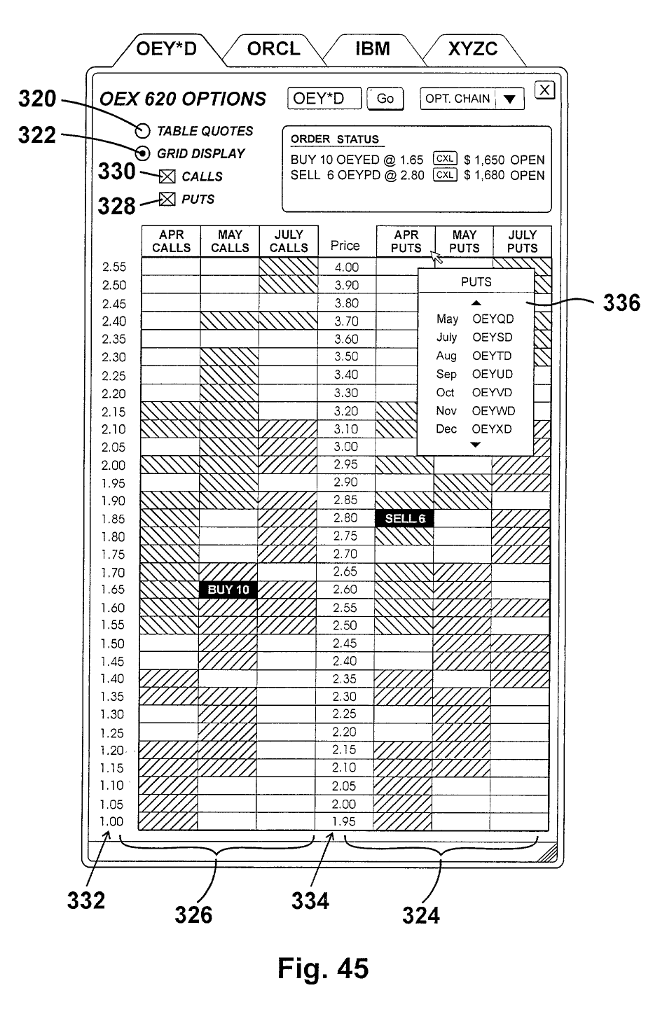

FIG. 45 shows an alternative representation of the option chain of FIG. 44. Both Puts 324 and Calls 326 are displayed in this view. The selection of which class to display is via the put and call check boxes 328, 330 under the “grid display” radio button 322. The price axes 332, 334 are independent of each other, to optimize the display of relevant quote and order data.

Changes can be made to the initial layout of the option chain. For example, the month to display in the put and call columns is via a right-click selection on the column name, as shown at 336.

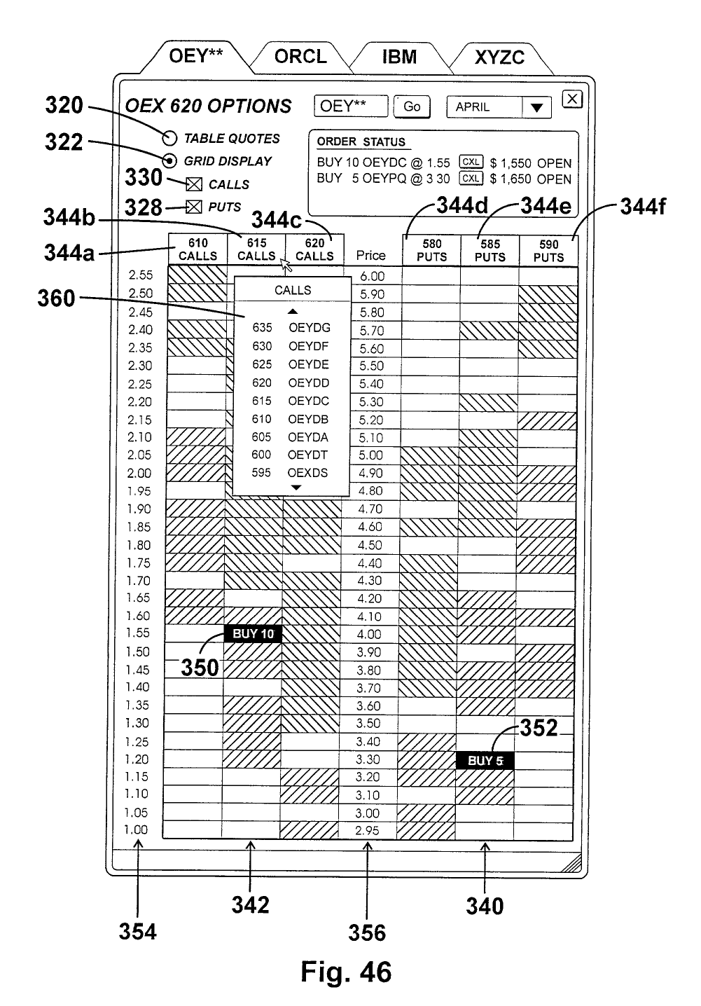

FIG. 46 shows yet another alternative representation of the option chain of FIG. 44. Both Puts and Calls are displayed in this view at 340 and 342, respectively. Each column 344a . . . 344f represents a different strike price for the month of April. Two limit buy orders 350, 352 are indicated: the first is for 10 contracts of the OEX April 615 calls at 1.55; the second buy order is for 5 contracts of the OEX April 585 puts at 3.30. The price axes 354, 356 for each class are independent each of the other. A right-click on the column heading allows the strike price to be changed, as shown at 360.

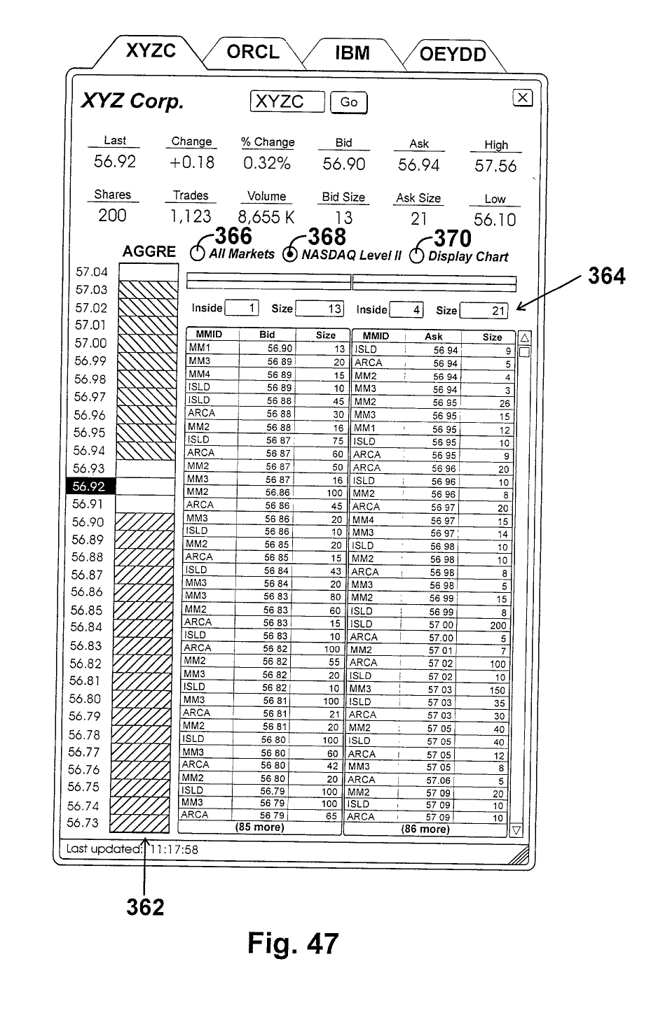

FIG. 47 is a representation of an aggregate column 362 of quote data and a corresponding NASDAQ Level II type display 364. Orders are entered or adjusted on the column according to market developments reflected in the Level II display. Although one column 362 is displayed to represent the aggregate data, the user may elect to show a second column to monitor a preferred market maker, exchange, or ECN—as market trading participant as referred to herein.

The radio buttons 366, 368, 370 on the Figure allow the trader to alternate views from a multiple column grid, to a split grid and Level II view, and to a grid and Chart view. A further view may include a grid and a chat discussion on the security, or news updates.

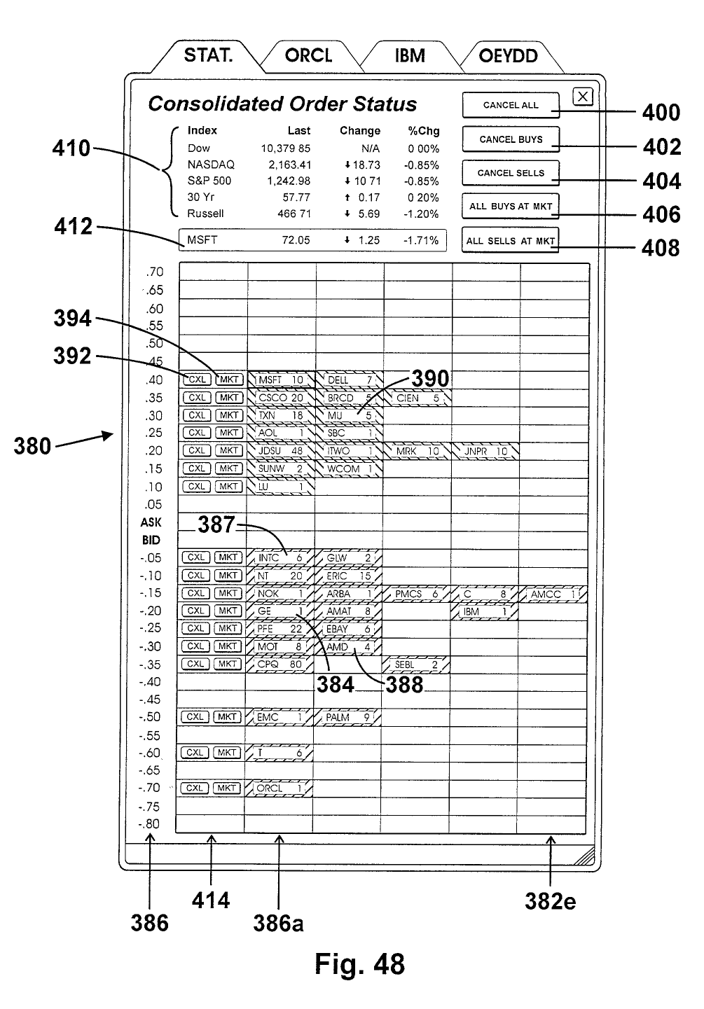

Turning now to FIG. 48, there is shown a consolidated view 380 of all open orders in a user's account. To obtain this view, the front end system 32 determines whether each open order is on the bid side or the ask side of the underlying security. Then, the front end system 32 plots the relative distance of each order from the security's bid or ask price. The price difference between the bid or ask price and the open limit order is plotted on a common grid and a relative price axis. It results in a cluster of orders around the normalized bid and ask reference points.

For example, GE in column 382a at 384 is an open limit order to buy one lot. The value on the price axis 386 is −0.20, which means that the user's buy order is about 0.20 away from the current bid of GE. If the bin increment was 0.01 instead of 0.05, a more exact calculation of the price gap would be possible. Orders can be dragged and dropped closer or further away from the trading activity. If an order is dragged to the opposite side of the market, the system assumes the order has changed to a market order and informs the backend accordingly.

There are two purposes for the columns 382a . . . 382e. The first is to allow multiple orders to overlap at a given price point or price bin. The left to right placement of orders when multiple orders reside in one bin, is determined by the orders closest to the bid or ask price. These orders are placed on the leftmost column. A second ranking variable may be the value of the trade, or the time interval since the order was submitted.

The second purpose for the columns 382a . . . 382e, is to allow open orders to be dragged left or right, away from the main cluster of orders so individual stocks or groups of stocks can be segregated and monitored in relation to the central order cluster. For example, semiconductor sector stocks such as INTC (386), AMD (388), and MU (390) may be dragged along the row to the right edge of the grid so the relative performance of those open orders may be monitored for signs of a deteriorating market or an upcoming rally.

The first column 414 contains two user-defined buttons 392, 394 in each cell. In this instance, the buttons are a cancel button, CXL, and a change limit order to market button, MKT, respectively. Pressing either button changes all orders in the relevant row to the designated command.

At the top of the tab page is a column of five larger buttons 400, 402, 404, 406, 408. When a market event such as a Federal Reserve Board meeting produces breaking news, the user can elect to cancel all open orders at 400, cancel all open buy orders at 402 or open sell orders at 404; or change all open limit buy and limit sell orders, at 406 and 408, respectively, to market orders. Major market moves may be determined by monitoring a defined group of indexes and stocks on the upper portion of the grid, at 410.

When a pointing device such as a mouse selects an order cell, the last price, change, and percentage change are displayed above the grid. The column headings are user selectable. In FIG. 48, the stock selected is Microsoft, and its quote data is visible below the value for the Russell 2000 Index at 412.

Each order may be cancelled or have its terms changed by a right click on the selected order cell and choosing the command from the resulting menu.

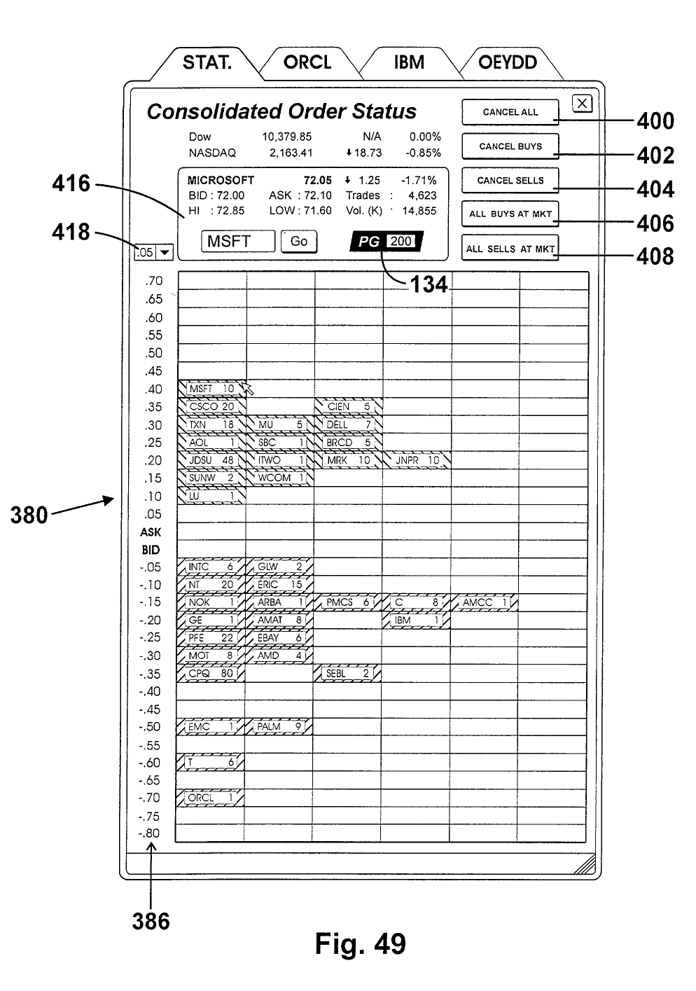

FIG. 49 shows an alternative representation of a consolidated view of all open orders with the same data as shown in FIG. 48. The relative price axis 386 allows a user to gauge the relative distance of any security from that security's bid or ask price. The first column 414 from FIG. 48 is hidden from view. A Position Guide 134 and stock ticker input area 416 above the grid, allow quote information and order quantity recommendations to be made. Dragging from the Position Guide 134 to the grid 380 allows the user to drop a buy, sell, or short order for the quoted security onto the grid. Placing the order below or on the BID price row of the grid designates it to be a limit buy order. Placing the order above or on the ASK price row of the grid designates it to be a limit sell or a limit short order. The row price bins may be adjusted using the drop down menu 418 near the relative price axis.

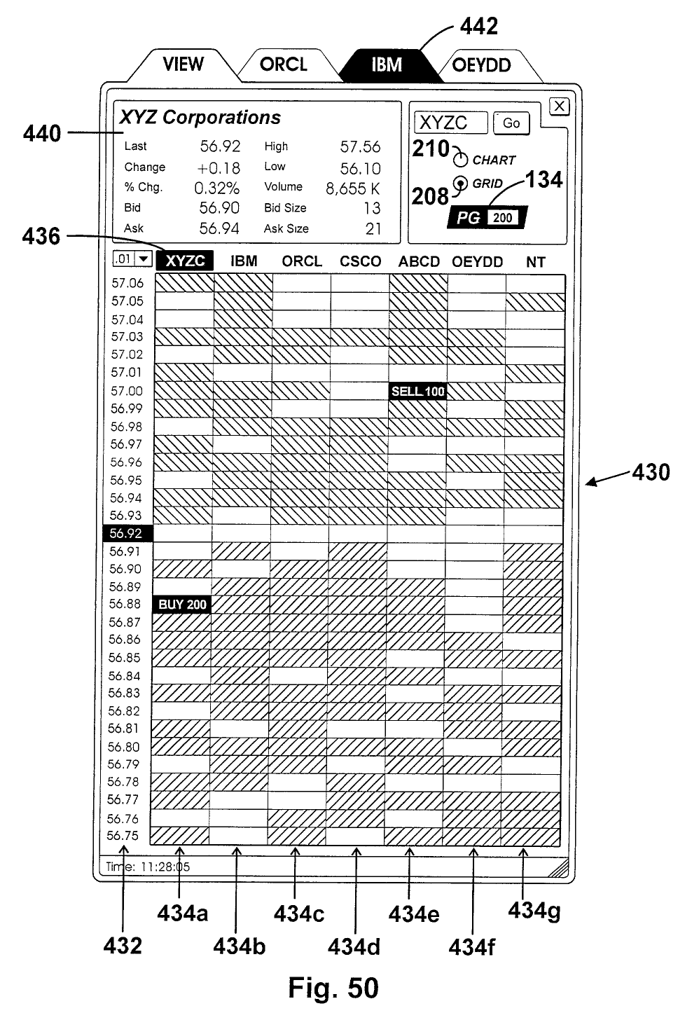

FIG. 50 is a representation of multiple securities quoted in one grid 430 with one price axis 432. The price axis 432 is adjusted in real time to reflect prices for the selected security assigned to a column 434a . . . 434g. In FIG. 50, XYZ Corp is the selected security and the price axis matches trading activity in XYZ Corp. The column name of XYZC is highlighted at 436 to distinguish it as the price axis reference.

This representation of the grid 430 makes it convenient to monitor multiple options and equities in a single, simple presentation. It also assists in tracking options prices when the underlying equity changes. The price bins adjust to the specific equity displayed so they do not need to be constantly adjusted. The selected column may also be dragged to the left or align automatically to the left so that it is next to the price column. The Position Guide 134 is active and relevant for the selected security.

The price axis can be an absolute value, or a relative value. If a relative value is used, the axis can be referenced to the bid, ask, last trade, high, low, open, a prior closing price or time interval, all as shown in box 440, or the value of a technical indicator. For example, a security close to its 50 day moving average can have the price axis referenced to the 50 DMA value, and the user can monitor the security to see if it holds the support level or falls under the moving average.

The selected security can be changed by entering a second symbol in the symbol text box. Summary information on the security appears on the upper section of the tab page. The tab 442 for “IBM” is highlighted in the tab set. This is an indication that an event has occurred that requires the user's attention. Such events may be orders that are filled, a trade through an important price level, or a recent news release.

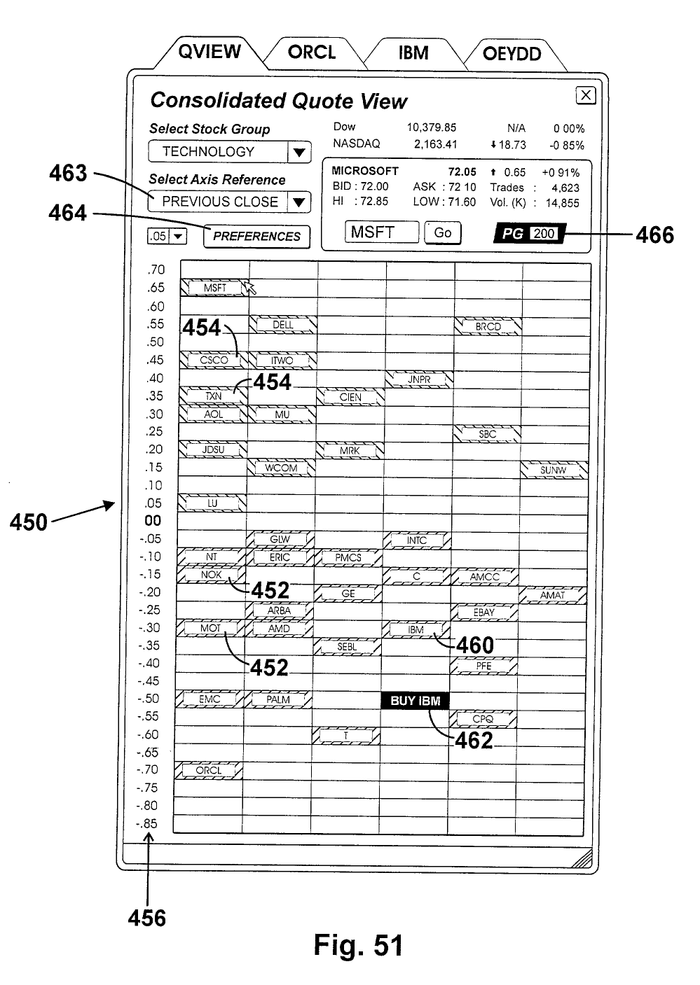

FIG. 51 is a representation of a grid 450 consisting of both order cells 452, and quote cells 454. Quote cells 454 represent a single security, and move on the grid in real time in accordance with a derived difference calculation between two or more parameters. Order cells 452 represent a limit order and can be dragged and dropped on the grid to adjust the order cell price in real time. Order cells associated with a given security's quote cell. As the quote cell and the order cell move towards each other along the price axis, the order comes closer to being filled. When the order cell and the quote cell are on the same price axis point, the order has the highest probability of being filled.

Entire grouping of stocks may be shown in this grid representation. Grouping may be index component stocks, industry sector stocks, a user defined list of securities, or a grouping selected on the basis of some technical criteria. The relative price axis 456 can compute the difference value between two selected criteria.

Two examples illustrate the use of this grid representation 450. In the first example, assume the relative price axis 456 value is derived from the difference between the prior closing price of a security and the last trade price during the current session. The grid 450 shows a quote cell 460 for IBM at negative 0.30 on the price axis. This is understood to mean that IBM's last trade in the current session is $0.30 below yesterday's closing price on IBM. The buy order 462 on IBM is seen to be $0.50 below yesterday's closing price, and $0.20 below the current last trade of IBM. If IBM falls, the quote cells will appear to fall towards the buy cell. If IBM continues to fall through the buy order, the order will be filled and reported as such. If the user feels that IBM will fall significantly past the buy order, the user can drag the buy order 462 down the price axis in order to lower the buy price for the IBM order.

In the second example, assume the relative price axis is the difference between the value of the 50 day moving average (50 DMA) of a stock and its last trade price. In this case, if we look at IBM at cell 460, we would interpret the grid as indicating that IBM is trading $0.30 below its 50 day moving average. The IBM buy order 462 represents a price point of $0.50 below IBM's 50 DMA. If IBM falls in price during the current trading session, the quote cell 460 would fall on the grid towards the buy order for IBM. If IBM continues to fall through the buy order 462, the order will be filled and reported as such. If the user feels that IBM will continue to fall further below the current buy price, the user can drag the buy order down the price axis in order to lower the buy price for the IBM order.

Orders can be entered directly from the tab page by selecting a quote cell. The Position Guide 134 will display a share recommendation, which can be adjusted as desired, and dragged onto the grid to the proper position in relation to the quote cell. A preferences button 464 allows users to customize settings and display options, and to create complex formulae, for the derived price axis value 456.

It should be understood that the relative price axis is derived by a price difference between two technical indicators, such as a moving average, or the prior session's closing price, and the last trade price of the displayed quote cell. The two values needed to derive the difference signal can be based on a simple statistic such as the last price, or the prior closing price. However, the two values can also be based on complex formulae involving multiple variables. With the use of multiple quote cells and groups of securities, general market trends would be more evident in this view than in a view of a single equity. A falling market would show the majority of quote cells falling on the grid. As noted earlier, the axis 456 values can be locked in position, or float to show the most representative view of all cells.

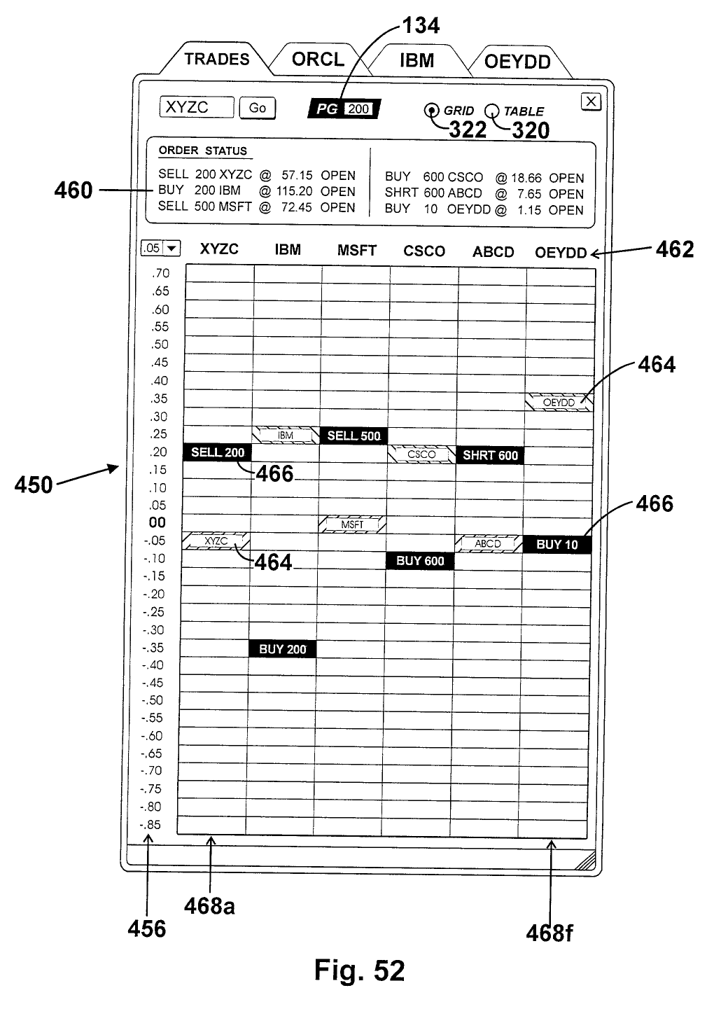

FIG. 52 represents a more orderly view of FIG. 51, wherein each column is associated with a unique security. The difference price axis 456 of FIG. 51 remains, as does the input methods to derive the difference value. An order status area 460 above the grid 450 allows fills to be reported for easy reference. Securities in a column can be changed by selecting a column heading or name, and entering an alternative ticker symbol in the text box 462.

Quote cells 464 and any order cells 466 for a specific security are located within a designated column 468a . . . 468f for that security. Each column can contain stocks, options, or other securities. Price quotes used as an input to derive the difference axis can be from one market or derived from aggregate market data.

Finally, turning to FIGS. 53a, 53b, and 53c, there are shown representations of how prices associated with a sequence of cells can be grouped into a single cell as the price range is expanded. On the left side of each of FIGS. 53a, 53b, and 53c, there are five cells 531, 532, 533, 534, and 535. As the bin size is changed from 0.01 to 0.05, the price axis contracts and the price range visible on the grid expands. The nominal bin price of 59.90, shown at 536 can be assigned from the top 53l, center 533, or bottom 535 position of the five cells, for example, with 0.01 price increments. Which five values are assigned to a five-cent bin, and how the nominal price of the bin is selected, is left to the user or the system administrator.

Since securities do not trade in increments finer than the Minimum Price Variance (MPV), the basic price sequence of cells on a grid are based on the MPV. Bin Cells, used when a grid is Zoomed out to show a “birds eye view” of trading activity, are comprised of multiples of marginal increment MPV cells. How smaller cells, such as 0.01 increment cells, map into larger 0.05 bin cells, affects which bin cells show a quote and which do not, as discussed above.

A standard protocol is interfaces is provided so as to define the format of instructions and data that are exchanged between any trader—that is, for communication from the graphical interface client front end 32 of that trader—and any backend system 44. That standard protocol may be based on the XML language.

Each of the input parameters and each of the return value items for the set of standard interface commands noted above is linked to a respective GUI object in the software which is at any trader's graphical interface client front end 32.

An interactive graphical front end system, and its relationship to a trading system where a plurality of traders and a plurality of market trading participants will be found, has been described.

The software, and particulars of the software, have been described to the extent necessary, it being understood that any person skilled in the art of writing software for the appropriate platform such as ActiveX, Windows, GUI-based systems, and so on, may write specific software, and may provide specific functional and logical architecture, without departing from the spirit and the scope of the appended claims.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. An interactive graphical front end trading system for use in trading securities through established security trading markets, in real time, where the system comprises a grid based graphical user interface for use by any trader; said system being adapted for communication between any trader and any of a plurality of market trading participants through communication channels between a computer at said trader's location middleware between said trader and any market trading participant, and backend systems used by any market trading participants;
wherein said graphical user interface for each trader is adapted to receive market data through said communications channels and said middleware from a plurality of market trading participants, in real time; and wherein any trader may select any particular security or group of securities for which data are electively required, at any instant in time;
wherein said graphical user interface comprises processor means that functions to send transaction instructions through a communication channel to a backend system of any market trading participant, and to receive messages back from any market trading participant through said middleware and said communication channels; and wherein said graphical user interface further comprises further processor means that functions to receive, process, and present said messages, and market data, to any trader;
wherein said messages and market data comprise information chosen from the group of information data consisting of: order data as to buy, sell, or other trading orders existing at that instant in time for any selected security or group of securities, quote data as to bid and ask prices for any security or group of security, volume data as to trading activity of any security or group of securities, index data, market information as to news or charts concerning any security or group of securities, and combinations thereof;
wherein said messages and market data are transmitted to said grid based graphical user interface from said backend systems of any market trading participant in computer-readable electronic format;
wherein upon receipt of said market data, said graphical user interface for any trader applies processor means that function to transform said market data, at any instant in time, into a graphical representation for display on a display device, which display comprises at least one grid comprising a plurality of cells;
wherein any selected cell displays specific market data, and the market data displayed in any one cell differs from the market data displayed in any other cell;
wherein said plurality of cells on said grid is presented in a grid display chosen from the group consisting of a plurality of rows and at least one column, a plurality of columns and at least one row, and a plurality of rows and a plurality of columns;
wherein a plurality of rows or a plurality of columns has an axis along which each selected cell indicates a price or price range for which market data exists, and wherein a second axis is established for at least one column or row is indicative of a specific criterion chosen from a plurality of selected criteria within which said market data may be categorized as to price or price range;
wherein any selected cell of said plurality of cells represents specific market data chosen from the group of data consisting of buy, sell, or other trading order for any security or group of securities, quote data as to bid and ask prices for any security or group of securities;
wherein any selected cell is electively linked to a selected parameter or group of parameters associated with said specific market data;
wherein said graphical user interface grid display further comprises at least one further data entry activator chosen from the group consisting of graphical buttons, transaction icons, data entry fields, and combination thereof; and
wherein any trader can execute or alter any trading order for a selected security or group of securities being displayed at that instant in time by an action chosen from the group of actions consisting of: clicking on a selected cell, moving a cursor or pointing a device over a selected cell and dragging that cell to said at least one data entry activator, dragging said at least one data entry activator over a selected cell, right clicking on a selected cell so as to reveal any selected parameters electively linked thereto and choosing a selected parameter, and combinations thereof.

2. The interactive graphical front end trading system of claim 1, wherein any selected cell in said plurality of cells is assigned specific visual or graphical attributes or properties chosen from the group of graphical or visual attribution or properties consisting of: color, border, label indicator, graphic overlay, text overlay, and combinations thereof;
wherein the specific attribute or property assigned to any selected cell is a function of the specific market data associated therewith.

3. The interactive graphical front end trading system of claim 1, wherein an existing trading order display in a selected cell on said grid is electively changed by a trader by dragging the selected cell to a new location on said grid display;
wherein said new location is linked to processor means that functions to alter a specific parameter associated with that trading order.

4. The interactive graphical front end trading system of claim 3, wherein said selected cell and said new location are electively altered as to their graphical or visual attributes or properties; and
wherein said altered graphical or visual attributes or properties are chosen from the group of graphical or visual attributes or properties consisting of: color, border, label indicator, graphic overlay, text overlay, and combinations thereof.

5. The interactive graphical front end trading system of claim 1, wherein said trading data is presented in a plurality of rows and a plurality of columns; and
wherein each selected cell, and each trading order transaction, is linked to a respective one of a set of GUI objects which are included in said software at said graphical user interface at each said trader.

6. The interactive graphical front end trading system of claim 1, wherein said system further comprises protocol translators for translating the data and instructions sent over any communications channel into a language which is understood by a computer at any trader's location, or at any market trading participant's location.

7. The interactive graphical front end trading system of claim 1, wherein said system server has logical components therein to execute any trading order instruction issued thereto from a trader, or from a market trading participant.

8. The interactive graphical front end trading system of claim 1, wherein said graphical user interface for any trader has a local database relevant to that trader.

9. The interactive graphical front end trading system of claim 1, wherein said system server has a central database relevant to the system.

10. The interactive graphical front end trading system of claim 1, wherein a selected security for which said trading data is displayed at any instant in time may be changed to another selected security by said software at each trader's location, at intervals selected by that trader.

11. The interactive graphical front end trading system of claim 1, wherein the trading data for any selected security for which the securities data is being displayed at any instant in time by any trader is constantly updated by being refreshed having regard to new trading data being received by the graphical user interface for that selected security.

12. The interactive graphical front end trading system of claim 1, wherein any backend system which is used by any market trading participant will perform at least the following tasks: account management for each trading account being handled by that market trading participant; processing trading orders for each transaction which that market trading participant undertakes to perform; order execution, whereby each transaction which that market trading participant undertakes to perform, is executed; datafeed handling, whereby the data concerning any trading order being handled by that market trading participant for any selected security is fed to said system server for dissemination on request to any trader; and system management for purposes of maintaining security and operation of the respective backend system of that market trading participant.

13. The interactive graphical front end trading system of claim 9, wherein each market trading participant is chosen from the group consisting of stock brokers, approved electronic communication network trading systems (ECN's), stock exchanges, commodity exchanges, futures exchanges, bourses, and auction servers.

14. The interactive graphical front end trading system of claim 1, wherein each selected security for which trading data is displayed is chosen from the group consisting of shares, commodities, futures, derivatives, puts, calls, and other share based options or contracts, and objects that are being sold at auction over internet-based auction systems.

15. The interactive graphical front end trading system of claim 1, wherein said data communications over said communications channels are in keeping with selected protocols which are established to standardize data interchange format between respective parties communicating over any respective communications channel, using secure data encryption modes.

16. The interactive graphical front end trading system of claim 9, wherein the backend system of any market trading participant further comprises a middleware system whose purposes include the following tasks: connection pooling, whereby securities data to and from that market trading participant is pooled and controlled so as to maintain the integrity thereof; an application server to assure access by the backend system to required software in order to perform any required function intended to be carried out by that market trading participant; and security management, whereby the security of the backend system against unwanted hacker intrusion is assured.

17. The interactive graphical front end trading system of claim 1, wherein data concerning any security holding which is held by any trader is represented on the display for that respective trader by at least one icon which is linked to a respective GUI object in the software at that trader's graphical user interface.

18. The interactive graphical front end trading system of claim 1, wherein any selected quantity of cash which is held by any trader in selected units thereof is represented on the display for that respective trader by at least one icon which is linked to a respective GUI object in the software at that trader's graphical user interface.

19. The interactive graphical front end trading system of claim 14, wherein additional icons are used to represent specific quantities of units of any selected security, and additional icons are used to represent selected amounts of cash; and
wherein, in each instance, each additional icon is linked to a respective further GUI object in the software at the trader's graphical user interface.

20. The interactive graphical front end trading system of claim 1, wherein the software at any trader's graphical user interface is application software, which is contained in a computer at the respective trader's location.

21. The interactive graphical front end trading system of claim 2, wherein the respective data being displayed in any selected cell comprises a plurality of specific components relating to selected parameters surrounding that data.

22. The interactive graphical front end trading system of claim 2, wherein a plurality of columns of cells is assigned to any one of a plurality of market trading participants, so that each selected cell represents only one specific trading order being posted by the respective market trading participant for the selected security being displayed at any instant in time.

23. The interactive graphical front end trading system of claim 2, wherein a selected quantity of the best buy orders and a selected quantity of the best sell orders, which are being posted by a selected market trading participant for a selected security, are displayed.

24. The interactive graphical front end trading system of claim 2, wherein any selected cell on the graphical display that has more than one trading order for a selected respective market trading participant at the respective price indicated by that cell, is marked to show the number of trading orders that are represented by that respective selected cell; and
wherein there is a link to a respective GUI object in the software at the respective trader's graphical user interface for each number that is displayed in any respective cell having more than one trading order.

25. The interactive graphical front end trading system of claim 1, wherein further data is embedded in each respective trading order cell, in the data for that respective cell, which further data is revealed by clicking on the respective cell;
wherein said further data at least includes an indication of the number of units of the selected security for which the respective trading order has been placed; and
wherein there is a link to a respective GUI object in the software at any trader's graphical user interface for the respective data being displayed.

26. The interactive graphical front end trading system of claim 1, wherein the graphical display at any trader's location includes Level I data for a selected security at any instant in time; and
wherein said Level I data includes data which is chosen from the group consisting of: the exchange where the selected security is being traded, the current bid price, the current ask price, the last sold price, the size of the last transaction in terms of the number of units of the selected security traded, the change in the price of the last trade with respect to the immediately preceding trade, the volume in terms of the number of units of the selected security that had been traded during the current trading session, and combinations thereof.

27. The interactive graphical front end trading system of claim 1, including a standard protocol that defines the format of instructions and data that are exchanged between any trader's graphical user interface client and any backend systems of any market trading participant.

28. The interactive graphical front end trading system of claim 27, wherein said standard protocol is based on the Extensible Markup Language (XML).

29. The interactive graphical front end trading system of claim 24, wherein each of said input parameters, and each of the return value items, is linked to a respective GUI object in the software at any trader's graphical user interface.

30. The interactive graphical front end trading system of claim 2, wherein a plurality of grids of rows and columns of data are graphically presented on a plurality of graphical tabbed pages, wherein each page is selected by clicking on its respective tab.

31. The interactive graphical front end trading system of claim 26, wherein a transaction may be effected by dragging and dropping an icon which is representative of a specific trading instruction, from one tabbed page on said display to another tabbed page.

32. The interactive graphical front end trading system of claim 1, wherein a transaction which changes a previous instructed transaction is handled by said transaction software, so as to appear to said trader as a single transaction.

33. The interactive graphical front end trading system of claim 1, wherein any trading order transaction may be effected by dropping an icon which is representative of the specific transaction onto a selected cell, whereby said transaction software will issue a respective transaction instruction through a respective communication channel to a respective market trading participant.

34. The interactive graphical front end trading system of claim 29, wherein any trading order transaction which has been placed but not yet effected, may be cancelled by dragging the respective icon away from its respective selected cell.

35. The interactive graphical front end trading system of claim 1, wherein the price value for each row is selectively adjustable as to the price or price range being represented by that row, and as to the relative position of any row with respect to any other row, along an axis thereof.

36. The interactive graphical front end trading system of claim 31, wherein the adjustment of the price value, and the adjustment of the relative position for each row, along the axis thereof, is under the control of said data handling software.

37. The interactive graphical front end trading system of claim 32, wherein the range of price values for all of the rows along the axis thereof which are displayed, and the price value for a selected row, is determined for each selected security at any instant in time as a factor of one of the criteria chosen from the group consisting of: the last closing price for that security, the opening price for that security, the highest price paid for that security, the highest price bid for that security, the lowest price paid for that security, the lowest price bid for that security, and the last price paid for that security.

38. The interactive graphical front end trading system of claim 1, wherein the criterion for said at least one column is chosen from the group consisting of: the identity of a market trading participant, aggregate trading order data from a plurality of market trading participants, aggregate buy order data from a plurality of trading participants, and aggregate sell order data from a plurality of trading participants.

39. The interactive graphical front end trading system of claim 1, wherein said display further includes a display page for an integrated chat session.

40. The interactive graphical front end trading system of claim 1, wherein said graphical user interface for any trader has memory means associated therewith, wherein all securities data for any selected security, at a series of selected time intervals, is stored in said memory; whereby a replay function for said data, to recall said data during a selected time period, may be selectively invoked by said trader.

41. The interactive graphical front end trading system of claim 1, further comprising software whose purpose is to review and weigh a trader's cash position and portfolio, so as to make a recommendation for a trading order for a selected security, at any instant in time, where the recommendation is a factor of at least the bid and ask prices for that security at that instant in time.

42. The interactive graphical front end trading system of claim 1, wherein the graphical display at any trader's location includes Nasdaq Level II data for a selected security at any instant in time; and
wherein said Nasdaq Level II data includes data which is chosen from the group consisting of: the identity of each market trading participant whose data is being displayed, the last price paid, the change between the last price paid and the previous price paid, the percentage change between the last price paid and the previous price paid, the current bid price, the current ask price, the highest price paid within a predetermined period of time, the number of shares traded in the last trade, the number of shares traded during a current trading session, the number of trades during the current trading session, the number of current bidders, the number of current sellers, and the lowest price paid within a predetermined period of time.

43. The interactive graphical front end trading system of claim 1, wherein any of said rows and said at least one column has a graphical control button associated therewith, whereby the status thereof may be changed under the control of said data handling software.

44. The interactive graphical front end trading system of claim 1, wherein a specific color is assigned for each different type of trading order data which is displayed in any selected cell.
